(19) United States
(12) Patent Application Publication
(10) Pub. No.: US 2026/0193531 A1
(43) Pub. Date: Jul. 9, 2026

(54) LIQUID WEIGHTING AGENTS FOR OIL-BASED FLUIDS

(71) Applicant: Albemarle Corporation, Charlotte, NC (US)

(72) Inventors: Yunqi LIU, Baton Rouge, LA (US); Joseph BAKER, Baton Rouge, LA (US); Huaxiang YANG, Sugar Land, TX (US); Garrett NIELSEN, Baton Route, LA (US); Donovan THOMPSON, Prairieville, LA (US); Gilles L. NUMKAM, Conroe, TX (US); Tse-Chong WU, Conroe, TX (US)

(73) Assignee: Albemarle Corporation, Charlotte, NC (US)

(21) Appl. No.: 19/129,596

(22) PCT Filed: Nov. 15, 2023
(86) PCT No.: PCT/US2023/079901

§ 371 Date: May 13, 2025

Related U.S. Application Data
(60) Provisional application No. 63/425,925, filed on Nov. 16, 2022.
(60) Provisional application No. 63/537,597, filed on Sep. 11, 2023.

(51) Int. Cl. C09K 8/82; C09K 8/035; E21B 41/00

(52) U.S. Cl. CPC C09K 8/82; C09K 8/035; E21B 41/00

(57) ABSTRACT

This invention provides compositions that can be used as oil-miscible liquid weighting agents.

### TECHNICAL FIELD

This invention relates to liquid weighting agents for oilfield applications.

### BACKGROUND

In some oilfield operations, the well fluids need to have a relatively high density, so one or more ingredients are added to the well fluid to increase the density of the well fluid. Brines are typically used to increase the density of aqueous well fluids, but some well fluids are oil-based. In oil-based fluids, solid weighting agents are often used to increase the well fluid density, but solid weighting agents often block pores and decrease production from the formation.

Liquid weighting agents are an alternative to solid weighting agents for oil-based well fluids, but may not be miscible with the oil-based fluid, may form emulsions with the oil-based well fluid, and/or cause solids formation. There is a need for oil-miscible weighting agents that do not form emulsions and/or cause precipitation.

### SUMMARY OF THE INVENTION

This invention provides liquid weighting agents that increase the density of oil-based well fluids, and can provide high density fluids. To achieve the increased density, the liquid weighting agent is made part of the oil-based well fluid. The liquid weighting agents of the invention can increase the densities of an oil-based well fluid to about 14.5 pounds per gallon (1.74 kg/L) or more. In addition to increasing the density of the fluid in which they are present, liquid weighting agents permit use of increased drill speeds. Another advantage of these liquid weighting agents is a greater amount of oil produced from the formation. Still another advantage of the liquid weighting agents of the present invention is that they do not significantly alter the fluid loss properties of formulations in which they are present. Yet another advantage provided by some of the liquid weighting agents of the invention is a minimal effect on the viscosity of the fluids to which they are introduced or combined; in some instances, liquid weighting agents of the invention reduce the viscosity of the fluids to which they are introduced or combined, so a change of equipment to larger pumps is not required. Another advantage provided by the liquid weighting agents of the invention is that they can be a component of optically clear fluids. Some of the liquid weighting agents of this invention have low sediment toxicity and some also are anaerobically biodegradable, and meet the U.S. Environmental Protection Agency requirements for offshore disposal of cuttings (formation debris) having an oil content of 6.9 wt % or less.

An embodiment of this invention is a liquid weighting agent containing two or more bromine atoms and having a bromine content of about 35 wt % or more. The liquid weighting agent is selected from
A) a bromine-containing monoester represented by the formula

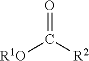

wherein R¹ contains a quaternary carbon atom, a terminal alkene moiety, or an aromatic-alkyl moiety, wherein the oxygen atom adjacent to R¹ is not bound to a quaternary carbon atom, an alkenyl carbon atom or an aromatic carbon atom, and R² is a hydrocarbyl group or a bromine-containing hydrocarbyl group;
B) a bromine-containing diester represented by the formula

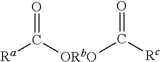

wherein R^{b} contains a quaternary carbon atom, or an internal alkene moiety, wherein the oxygen atoms adjacent to R^{b} are not bound to a quaternary carbon atom or an alkenyl carbon atom, and R^{a} and R^{c} are each, independently, a hydrocarbyl group or a bromine-containing hydrocarbyl group;
C) a bromine-containing triester which has at least seven carbon atoms and is represented by the formula

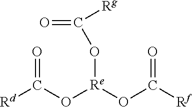

wherein R^{d}, R^{e}, R^{f}, and R^{g} are each, independently, a hydrocarbyl group or a bromine-containing hydrocarbyl group, and at least one of R^{d}, R^{e}, R^{f}, and R^{g} is a bromine-containing hydrocarbyl group; and
D) any two or more of the foregoing.

More specifically, the bromine-containing monoester is
i) a bromine-containing monoester that has seven or more carbon atoms and R¹ contains a quaternary carbon atom,
ii) a bromine-containing monoester that has five or more carbon atoms and R¹ contains a terminal alkene moiety,
iii) a bromine-containing monoester that has nine or more carbon atoms and R¹ contains an aromatic-alkyl moiety.

The bromine-containing diester is
i) a bromine-containing diester that has nine or more carbon atoms and R^{b} contains a quaternary carbon atom,
ii) a bromine-containing diester that has eight or more carbon atoms and R^{b} contains an internal alkene moiety.

Another embodiment of this invention is an oil-based well fluid comprising a liquid weighting agent selected from the bromine-containing esters described above.

These and other embodiments and features of this invention will be still further apparent from the ensuing description and appended claims.

### FURTHER DETAILED DESCRIPTION OF THE INVENTION

As used throughout this document, the phrase “alkenyl carbon atom” refers to a carbon atom that is part of a double bond. Throughout this document, the phrase “aromatic carbon atom” refers to a carbon atom that is part of an aromatic ring.

Throughout this document, both “ppg” and “lb/gal” are abbreviations for pounds per gallon.

Some of the liquid weighting agents of this invention are usable as oil-miscible weighting agents (OMWA). As used throughout this document, the term “miscible” means that emulsions and/or separate phases are not observed in a 50:50 weight mixture of one or more of the liquid weighting agents of this invention (total of 50 wt %) and an oil (50 wt %) after the mixture has been kept at 0° C. for one week. Similarly, as used throughout this document, the term “partially miscible” means that emulsions and/or separate phases are not observed in a 50:50 weight mixture of one or more of the liquid weighting agents of this invention (total of 50 wt %) and an oil (50 wt %) after the mixture has been kept at room temperature for one week.

The liquid weighting agents of the present invention are generally miscible with oil-based well fluids. In the practice of this invention, the liquid weighting agents are often in a mixture with an oil. Oils with which the liquid weighting agents are optionally mixed are oils which usually have a viscosity of about 7 cP or less, and a density typically about 0.7 g/mL to about 0.9 g/mL. The amount of liquid weighting agent in the oil can be about 0.1 wt % to 100 wt %; when more than one liquid weighting agent is used, the amount refers to the total amount of liquid weighting agents. When there is 100 wt % liquid weighting agent of the invention, no other substance is present with the liquid weighting agent. Preferred amounts of liquid weighting agent in the oil depend on the desired density, and there is typically about 0.1 wt % to 100 wt % liquid weighting agent in a mixture with an oil, more often about 0.1 to about 99.9 wt %, preferably about 2 wt % to about 99.9 wt % liquid weighting agent in a mixture with an oil. The mixture of oil and the liquid weighting agent(s) usually have a viscosity of about 10 cP or less, and a density typically about 0.7 g/mL to about 1.8 g/mL.

The liquid weighting agents of this invention share some overall characteristics. In these liquid weighting agents, there are two or more bromine atoms in the molecule, and a bromine content of 35 wt % or more, preferably about 35 wt % to about 70 wt %, more preferably about 35 wt % to about 65 wt %, relative to the total weight of the liquid weighting agent. The densities of the liquid weighting agents of the invention are generally about 1.20 g/mL or more.

In some embodiments, the liquid weighting agent is a bromine-containing monoester which is represented by the formula

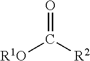

where R¹ contains a quaternary carbon atom, a terminal alkene moiety, or an aromatic-alkyl moiety, wherein the oxygen atom adjacent to R¹ is not bound to a quaternary carbon atom, an alkenyl carbon atom or an aromatic carbon atom, and R² is a hydrocarbyl group or a bromine-containing hydrocarbyl group. Preferably, the two bromine atoms are bound to carbon atoms adjacent to quaternary carbon atoms, to alkenyl carbon atoms, or to aromatic carbon atoms. When there are more than two bromine atoms in the molecule, it is preferred that two or more bromine atoms are bound to carbon atoms adjacent to quaternary carbon atoms, to alkenyl carbon atoms, or to aromatic carbon atoms. The bromine-containing monoesters typically have a bromine content of about 35 wt % or more, preferably about 40 wt % or more, more preferably about 45 wt % or more.

When the bromine-containing monoester has seven or more carbon atoms and R¹ contains a quaternary carbon atom, the monoester preferably has seven to about twenty carbon atoms, more preferably seven to about fifteen carbon atoms, still more preferably seven to about twelve carbon atoms, in the molecule. The group of the bromine-containing monoester that contains the quaternary carbon atom preferably has five to about fifteen carbon atoms, more preferably five to about ten carbon atoms. Suitable quaternary carbon atom moieties include 2,2-dimethyl-1-propyl and 3,3-dimethylbut-1-yl; 2,2-dimethylprop-1-yl (neopentyl) is a preferred quaternary carbon atom moiety. Preferably, the two bromine atoms are bound to carbon atoms adjacent to a quaternary carbon atom. When there are more than two bromine atoms in the molecule, it is preferred that two or more bromine atoms are bound to carbon atoms adjacent to quaternary carbon atoms. Preferably, there are three or more bromine atoms in the molecule; more preferably three or more carbon atoms are bound to carbon atoms adjacent to a quaternary carbon atom. Bromine-containing monoesters of this invention comprising a quaternary carbon atom typically have a bromine content of about 35 wt % or more, preferably about 40 wt % or more, more preferably about 50 wt % or more, still more preferably about 55 wt % or more, and often have densities of about 1.20 g/mL or more, preferably about 1.30 g/mL or more, more preferably about 1.45 g/mL or more.

When the bromine-containing monoester has five or more carbon atoms and R¹ contains a terminal alkene moiety, the monoester preferably has five to about twenty carbon atoms, more preferably five to about fifteen carbon atoms, more preferably five to about ten carbon atoms, in the molecule. The group of the bromine-containing monoester that contains the terminal alkene moiety preferably has three to about ten carbon atoms, more preferably three to about eight carbon atoms, still more preferably three to about six carbon atoms, even more preferably three to about four carbon atoms. Suitable terminal alkene moieties include 2-propenyl, 3-butenyl, 4-pentenyl, 5-hexenyl, 6-heptenyl, 7-octenyl, 8-nonenyl, and 9-decenyl; 2-propenyl (sometimes referred to as an allyl group) is a preferred terminal alkene moiety. Preferably, the two bromine atoms are bound to alkenyl carbon atoms. When there are more than two bromine atoms in the molecule, it is preferred that two or more bromine atoms are bound to alkenyl carbon atoms. Bromine-containing monoesters of this invention comprising a terminal alkene moiety typically have a bromine content of about 35 wt % or more, preferably about 40 wt % or more, more preferably about 50 wt % or more, still more preferably about 55 wt % or more.

When the bromine-containing monoester has nine or more carbon atoms and R¹ contains an aromatic-alkyl moiety, the monoester preferably has nine to about twenty carbon atoms, more preferably nine to about fifteen carbon atoms, in the molecule. The group of the bromine-containing monoester that contains the aromatic-alkyl moiety preferably has seven to about fifteen carbon atoms, more preferably seven to about twelve carbon atoms. The aromatic ring of the aromatic-alkyl moiety may contain one or more hydrocarbyl substituents, which preferably have one to about four carbon atoms. The alkyl portion of the aromatic-alkyl moiety typically contains one to about four carbon atoms and can be straight-chain or branched; preferably, the alkyl portion has one or two carbon atoms. A preferred aromatic-alkyl moiety is a phenylmethyl (benzyl) moiety. Preferably, the two bromine atoms are bound to aromatic carbon atoms. When there are more than two bromine atoms in the molecule, it is preferred that two or more bromine atoms are bound to aromatic carbon atoms. Bromine-containing monoesters of this invention comprising an aromatic-alkyl moiety typically have a bromine content of about 35 wt % or more, preferably about 40 wt % or more, more preferably about 50 wt % or more, still more preferably about 55 wt % or more, and often have densities of about 1.20 g/mL or more, preferably about 1.30 g/mL or more, more preferably about 1.45 g/mL or more.

R² is a hydrocarbyl group or a bromine-containing hydrocarbyl group. When R² is a hydrocarbyl group, the group can be saturated or unsaturated, straight chain, branched, cyclic, or aromatic; preferably the hydrocarbyl group is a saturated straight chain or a saturated branched chain. Suitable hydrocarbyl groups include methyl, ethyl, n-propyl, 2-propyl, 2-methylpropyl, n-butyl, n-pentyl, cyclopentyl, hexyl, and cyclohexyl; methyl, ethyl, n-propyl, 2-propyl, 2-methylpropyl, n-butyl, and n-pentyl are preferred. When R² is a bromine-containing hydrocarbyl group, the group contains one or more bromine atoms, and the group can be saturated or unsaturated, straight chain, branched, cyclic, or aromatic. Preferably, the bromine-containing hydrocarbyl group is a saturated straight chain or a saturated branched chain; preferably, there are one or two bromine atoms in the bromine-containing hydrocarbyl group. Suitable bromine-containing hydrocarbyl groups include bromomethyl, 1-bromoethyl, 2-bromoethyl, 1,2-dibromoethyl, 3-bromo-n-propyl, 2,3-dibromo-n-propyl, 1,3-dibromo-2-propyl, 2-(bromomethyl)propyl, 2-(bromomethyl)-3-bromopropyl, 4-bromo-n-butyl, 3,4-dibromo-n-butyl, 4-bromo-n-pentyl, 4,5-dibromo-n-pentyl, 3-bromocyclopentyl, 3,4-dibromocyclopentyl, 6-bromohexyl, 5,6-dibromohexyl, 4-bromocyclohexyl; 3,4-dibromocyclohexyl and 2,6-dibromocyclohexyl; preferred are bromomethyl and 1-bromoethyl, especially bromomethyl.

Suitable bromine-containing monoesters in which R¹ contains a quaternary carbon atom in the practice of this invention include 3-bromo-2,2-bis(bromomethyl)propyl acetate, 3-bromo-2,2-bis(bromomethyl)propyl propionate, 3-bromo-2,2-bis(bromomethyl)propyl butyrate, 3-bromo-2,2-bis(bromomethyl)propyl 2-methylpropanoate, 3-bromo-2,2-bis(bromomethyl)propyl pentanoate, 3-bromo-2,2-bis(bromomethyl)propyl isovalerate, and 3-bromo-2,2-bis(bromomethyl)propyl hexanoate. Preferred bromine-containing monoesters in which R¹ contains a quaternary carbon atom include 3-bromo-2,2-bis(bromomethyl)propyl 2-methylpropanoate.

Suitable bromine-containing monoesters in which R¹ contains a terminal alkene moiety in the practice of this invention include 2,3-dibromoallyl acetate, 2,3-dibromoallyl propionate, and 2,3-dibromoallyl 2-methylpropanoate. Preferred bromine-containing monoesters in which R¹ contains a terminal alkene moiety include 2,3-dibromoallyl 2-methylpropanoate.

Suitable bromine-containing monoesters in which R¹ contains an aromatic-alkyl moiety (3,5-in the practice of this invention include (3,5-dibromophenyl)methyl acetate, dibromophenyl)methyl bromoacetate, (3,5-dibromophenyl)methyl propionate, (3,5-dibromophenyl)methyl butyrate, (3,5-dibromophenyl)methyl 2-methylpropanoate, and (3,5-dibromophenyl)methyl pentanoate. Preferred bromine-containing monoesters in which R¹ contains an aromatic-alkyl moiety include (3,5-dibromophenyl)methyl pentanoate.

In some embodiments, the liquid weighting agent is a bromine-containing diester which is represented by the formula

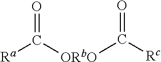

wherein R^{b} contains a quaternary carbon atom or an internal alkene moiety, wherein the oxygen atoms adjacent to R^{b} are not bound to a quaternary carbon atom or an alkenyl carbon atom, and R^{a} and R^{c} are each, independently, a hydrocarbyl group or a bromine-containing hydrocarbyl group. Preferably, the two bromine atoms are bound to carbon atoms adjacent to quaternary carbon atoms, to alkenyl carbon atoms, or to aromatic carbon atoms. When there are more than two bromine atoms in the molecule, it is preferred that two or more bromine atoms are bound to carbon atoms adjacent to quaternary carbon atoms, to alkenyl carbon atoms, or to aromatic carbon atoms. The bromine-containing diesters typically have a bromine content of about 35 wt % or more, and often have densities of about 1.20 g/mL or more.

When the bromine-containing diester has nine or more carbon atoms and R^{b} contains a quaternary carbon atom, the diester preferably has seven to about thirty carbon atoms, more preferably seven to about twenty-five carbon atoms, still more preferably seven to about twenty carbon atoms, in the molecule. The group of the bromine-containing diester that contains the quaternary carbon atom preferably has five to about ten carbon atoms, more preferably five to about eight carbon atoms. Suitable quaternary carbon atom moieties include 2,2-dimethylpropane-1,3-diyl and 3,3-dimethylpentane1,3-diyl; 2,2-dimethylpropane-1,3-diyl is a preferred quaternary carbon atom moiety. Preferably, the two bromine atoms are bound to carbon atoms adjacent to a quaternary carbon atom. When there are more than two bromine atoms in the molecule, it is preferred that two or more bromine atoms are bound to carbon atoms adjacent to a quaternary carbon atom. Bromine-containing diesters of this invention comprising a quaternary carbon atom typically have a bromine content of about 35 wt % or more, and often have densities of about 1.20 g/mL or more.

When the bromine-containing diester has eight or more carbon atoms and R^{b} contains an internal alkene moiety, the diester preferably has eight to about thirty carbon atoms, more preferably eight to about twenty-five carbon atoms, still more preferably eight to about twenty carbon atoms in the molecule. The group of the bromine-containing diester that contains the internal alkene moiety preferably has four to about eight carbon atoms, more preferably four to about six carbon atoms. Suitable internal alkene moieties include 2-butene, 2-pentene, 2-hexene, 3-hexene, 2-octene 3-octene, and 4-octene; preferred internal alkene moieties include 2-butene. Preferably, the two bromine atoms are bound to alkenyl carbon atoms. When there are more than two bromine atoms in the molecule, it is preferred that two or more bromine atoms are bound to alkenyl carbon atoms. Bromine-containing diesters of this invention comprising an internal alkene moiety typically have a bromine content of about 35 wt % or more, preferably about 40 wt % or more, and often have densities of about 1.20 g/mL or more, preferably about 1.30 g/mL or more, more preferably about 1.35 g/mL or more.

R^{a} and R^{c} are each, independently, a hydrocarbyl group or a bromine-containing hydrocarbyl group. When R^{a} and/or R^{c} are a hydrocarbyl group, the group can be saturated or unsaturated, straight chain, branched, cyclic, or aromatic; preferably the hydrocarbyl group is a saturated straight chain or a saturated branched chain. Suitable hydrocarbyl groups include methyl, ethyl, n-propyl, 2-propyl, 2-methylpropyl, n-butyl, n-pentyl, cyclopentyl, hexyl, and cyclohexyl; methyl, ethyl, n-propyl, 2-propyl, 2-methylpropyl, n-butyl, and n-pentyl are preferred. When R^{a} and R^{c} are a bromine-containing hydrocarbyl group, the group contains one or more bromine atoms, and the group can be saturated or unsaturated, straight chain, branched, cyclic, or aromatic. Preferably, the bromine-containing hydrocarbyl group is a saturated straight chain or a saturated branched chain; preferably, there are one or two bromine atoms in the bromine-containing hydrocarbyl group. Suitable bromine-containing hydrocarbyl groups include bromomethyl, 1-bromoethyl, 2-bromoethyl, 1,2-dibromoethyl, 3-bromo-n-propyl, 2,3-dibromo-n-propyl, 1,3-dibromo-2-propyl, 2-(bromomethyl)propyl, 2-(bromomethyl)-3-bromopropyl, 4-bromo-n-butyl, 3,4-dibromo-n-butyl, 4-bromo-n-pentyl, 4,5-dibromo-n-pentyl, 3-5,6-dibromohexyl, 4-bromocyclopentyl, 3,4-dibromocyclopentyl, 6-bromohexyl, bromocyclohexyl; 3,4-dibromocyclohexyl and 2,6-dibromocyclohexyl; preferred are bromomethyl and 1-bromoethyl, especially bromomethyl.

Suitable bromine-containing diesters in which R^{b} contains a quaternary carbon atom in the practice of this invention include 2,2-bis(bromomethyl) 1,3-diacetoxypropane, 2,2-bis(bromomethyl) 1,3-propanediol-1,3-dipropionate, 2,2-bis(bromomethyl) 1,3-propanediol-1,3-di(2-methylpropanoate), 2,2-bis(bromomethyl) 1,3-propanediol-1,3-dihexanoate, and 2,2-bis(bromomethyl) 1,3-propanediol-1,3-bis-(bromoacetate). Preferred bromine-containing saturated diesters include 2,2-bis(bromomethyl) 1,3-propanediol-1,3-dihexanoate.

Suitable bromine-containing diesters in which R^{b} contains an internal alkene moiety in the practice of this invention include (2E)-2,3-dibromobut-2-ene-1,4-diyl bis(propanoate), (2E)-2,3-dibromobut-2-ene-1,4-diyl bis(2-methylpropanoate), (2E)-2,3-dibromobut-2-ene-1,4-diyl bis(2′-bromobutyrate), (2Z)-but-2-ene-1,4-diyl bis(bromoacetate). Preferred bromine-containing diesters containing an internal alkene moiety include (2E)-2,3-dibromobut-2-ene-1,4-diyl bis(propanoate).

In some embodiments, the liquid weighting agent is a bromine-containing triester which has at least seven carbon atoms and at least two bromine atoms, and is represented by the formula

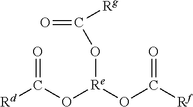

in which R^{d}, R^{e}, R^{f}, and R^{g} are each, independently, a hydrocarbyl group or a bromine-containing hydrocarbyl group, and at least one of R^{d}, R^{e}, R^{f}, and R^{g} is a bromine-containing hydrocarbyl group.

When R^{d}, R^{e}, R^{f}, or R^{g} is a hydrocarbyl group, the group can be saturated or unsaturated, straight chain, branched, cyclic, or aromatic; preferably the hydrocarbyl group is a saturated straight chain or a saturated branched chain. Suitable hydrocarbyl groups include methyl, ethyl, n-propyl, 2-propyl, 2-methylpropyl, n-butyl, n-pentyl, cyclopentyl, hexyl, and cyclohexyl; methyl, ethyl, n-propyl, 2-propyl, 2-methylpropyl, n-butyl, and n-pentyl are preferred. When R^{d}, R^{e}, R^{f}, or R^{g} is a bromine-containing hydrocarbyl group, the group contains one or more bromine atoms, and the group can be saturated or unsaturated, straight chain, branched, cyclic, or aromatic. Preferably, the bromine-containing hydrocarbyl group is a saturated straight chain or a saturated branched chain; preferably, there are one or two bromine atoms in the bromine-containing hydrocarbyl group. Suitable bromine-containing hydrocarbyl groups include bromomethyl, 1-bromoethyl, 2-bromoethyl, 1,2-dibromoethyl, 3-bromo-n-propyl, 2,3-dibromo-n-propyl, 1,3-dibromo-2-propyl, 2-(bromomethyl)propyl, 2-(bromomethyl)-3-bromopropyl, 4-bromo-n-butyl, 3,4-dibromo-n-butyl, 4-bromo-n-pentyl, 4,5-dibromo-n-pentyl, 3-bromocyclopentyl, 3,4-dibromocyclopentyl, 6-bromohexyl, 5,6-dibromohexyl, 4-bromocyclohexyl; 3,4-dibromocyclohexyl and 2,6-dibromocyclohexyl; preferred are bromomethyl and 1-bromoethyl, especially bromomethyl.

Suitable bromine-containing triesters in the practice of this invention include 1,2,3-propanetriyl tris (bromoacetate) and 1,2,3-propanetriyl tris(3-bromopropanoate). Preferred bromine-containing triesters include 1,2,3-propanetriyl tris (bromoacetate).

Combinations of any two or more of the above liquid weighting agents can be used in the practice of this invention.

Some of the liquid weighting agents of the invention have enough high-temperature thermal stability that they can be used in HPHT (high pressure, high temperature) conditions. HPHT conditions are usually defined as a temperature greater than about 250° F. (121° C.) and a pore pressure greater than about 0.8 psi/ft (15.3 lb/gal). In addition, the liquid weighting agents of the invention, when used in offshore applications, need low-temperature thermal stability because temperatures at the sea floor can be around 5° C.

It is often useful to include one or more optional additives with the liquid weighting agents, especially in a well fluid, and the inclusion of such additives is within the scope of this invention. Optional additives can include, for example, other weighting agents, corrosion inhibitors, lubricants, pH control additives, surfactants, and/or solvents.

Preferred types of optional additives in the practice of this invention are unsaturated diesters and saturated triesters that do not contain bromine. When the additive is an unsaturated diester, the unsaturated diester has at least eight carbon atoms and is represented by the formula

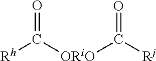

where R^{h} and Rⁱ are hydrocarbyl groups, and Rⁱ is an alkene-containing moiety. R^{h} and Rⁱ can be straight chain, branched, cyclic, or aromatic; preferably the hydrocarbyl group is a straight chain. Suitable hydrocarbyl groups include methyl, ethyl, n-propyl, 2-propyl, n-butyl, pentyl, cyclopentyl, hexyl, and cyclohexyl; ethyl and n-propyl are preferred. Rⁱ preferably has four to about eight carbon atoms, more preferably four to about six carbon atoms; suitable alkene-containing moieties include 2-butene, 2-pentene, 2-hexene, 3-hexene, 2-octene 3-octene, and 4-octene; preferred alkene-containing moieties include 2-butuene.

When the additive is a saturated triester, the saturated triester has at least seven carbon atoms and is represented by the formula

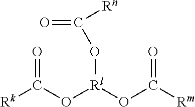

where R^{k}, R^{l}, R^{m}, and Rⁿ are hydrocarbyl groups. R^{k}, R^{m}, and Rⁿ can be straight chain, branched, or cyclic; preferably the hydrocarbyl group is a straight chain. Suitable hydrocarbyl groups include methyl, ethyl, n-propyl, 2-propyl, n-butyl, pentyl, cyclopentyl, hexyl, cyclohexyl, and phenyl; ethyl and n-propyl are preferred. R^{l} can be branched or cyclic, or aromatic; preferably R¹ is a saturated branched chain. Suitable hydrocarbyl groups include propyl, butyl, 2-pentyl, 3-pentyl, cyclopentyl, 2-hexyl, 3,-hexyl, and cyclohexyl; 2-propyl is a preferred group.

Suitable unsaturated diesters that do not contain bromine include but-2-ene-1,4-diyl diacetate, but-2-ene-1,4-diyl bis(propanoate), but-2-ene-1,4-diyl bis(butyrate), but-2-ene-1,4-diyl bis(pentanoate), pent-2-ene-1,5-diyl diacetate, pent-3-ene-1,5-diyl diacetate, pent-3-ene-1,5-diyl bis(propanoate); preferred is but-2-ene-1,4-diyl bis(butyrate). Suitable saturated triesters that do not contain bromine include propane-1,2,3-triyl triacetate, propane-1,2,3-triyl propanoate, propane-1,2,3-triyl tributyrate; preferred is propane-1,2,3-triyl tributyrate. Combinations of any two or more unsaturated diesters and/or saturated triesters can be used in the practice of the invention.

A particularly preferred combination with a saturated triester is a combination of a mixture of esters comprising (2E)-2,3-dibromobut-2-ene-1,4-diyl dipropanoate, (2E)-2,3-dibromobut-2-ene-1,4-diyl dibutanoate, (2E)-2,3-dibromo-4-[(propionyl)oxy]but-2-en-1-yl butanoate with propane-1,2,3-triyl tributyrate, where the propane-1,2,3-triyl tributyrate is typically present in an amount of about 0.25 wt % to about 20 wt %, preferably about 0.5 wt % to about 15 wt %, relative to the total weight of the combination.

Processes for forming mixtures of a liquid weighting agent and an oil, which oil can be a paraffin, mineral, olefinic, or ester oil, comprise combining the oil and the liquid weighting agent in any order. For example, an oil and the liquid weighting agent(s) can be added sequentially, or they can be introduced to a vessel or location simultaneously.

Any optional additives that are included can be combined with the liquid weighting agents in any convenient manner. When the liquid weighting agent is in a mixture with an oil, optional additives can be added before, during, and/or after formation of the mixture of an oil and the liquid weighting agent.

In some embodiments of the invention, a mixture of an oil and one or more liquid weighting agents of the invention is solids-free.

Although mixtures comprising liquid weighting agents are preferably solids-free, in some instances, one or more liquid weighting agents of the invention can be part of a mixture containing one or more solids, for example a solid weighting agent such as barite, if desired. In these instances, the use of a liquid weighting agent of the invention will reduce the amount of solid weighting agent needed to achieve the desired density.

In some well fluids, the presence of some solids is not disadvantageous. Calcium carbonate is often present as a suspension in a well fluid. The calcium carbonate often forms a filter cake that prevents the drilling fluid from entering the formation. After drilling, an acid treatment can be used to remove the calcium carbonate filter cake.

One or more liquid weighting agents of the invention can be combined with an oil-based well fluid. The oil-based well fluid can be a drilling fluid; completion fluids including but not limited to a packer fluid, a screen running fluid, or a carrier fluid; a (reservoir) drill-in fluid; a tractor fluid; a camera fluid; or workover fluids including but not limited to a coiled tubing drilling fluid. The liquid weighting agents of the invention can be combined with the well fluid alone or in admixture with one or more other additives and/or in a mixture with an oil.

The liquid weighting agents of the invention can be used as secondary fluids (“kill fluids”) to minimize or relieve sustained casing pressure in a wellbore annulus. The term “annular fluid” refers to the first fluid, which is present in the wellbore annulus before the second fluid is introduced. The second fluid can be introduced at the wellhead or below the surface of the annular fluid; subsurface introduction of the kill fluid is generally preferred. For treating sustained casing pressure, immiscibility refers to the non-mixing or substantial non-mixing of the liquid weighting agents and the (aqueous) annular fluid. See in this connection International Publication WO 2015/100004.

The liquid weighting agents of this invention can be used as additives for hydraulic fluids. Preferably, the liquid weighting agent of the invention is about 35 wt % or more relative to the total weight of the hydraulic fluid and the liquid weighting agent of the invention. In terms of bromine content, there is about 20 wt % to about 70 wt % bromine relative to the total weight of the hydraulic fluid and the liquid weighting agent of the invention. Other additives, such as antioxidants, lubricity agents, and metal deactivators, may also be present in the hydraulic fluid.

The molecules 3-bromo-2,2-bis(bromomethyl)propyl propionate; 3-bromo-2,2-bis(bromomethyl)propyl butyrate; 3-bromo-2,2-bis(bromomethyl)propyl 2-methylpropanoate; 3-bromo-2,2-bis(bromomethyl)propyl pentanoate; 3-bromo-2,2-bis(bromomethyl)propyl isovalerate; 3-bromo-2,2-bis(bromomethyl)propyl hexanoate; (3,5-dibromophenyl)methyl propionate; (3,5-dibromophenyl)methyl butyrate; (3,5-dibromophenyl)methyl 2-methylpropanoate; (3,5-dibromophenyl)methyl pentanoate; 2,2-bis(bromomethyl) 1,3-propanediol-1,3-dipropionate; 2,2-bis(bromomethyl) 1,3-propanediol-1,3-di(2-methylpropanoate); 2,2-bis(bromomethyl) 1,3-propanediol-1,3-dihexanoate; 2,2-bis(bromomethyl) 1,3-propanediol-1,3-bis-(bromoacetate); (2E)-2,3-dibromobut-2-ene-1,4-diyl bis(propanoate); and (2Z)-but-2-ene-1,4-diyl bis(bromoacetate) are new compositions of matter.

Some mixtures of diesters are new compositions of matter, including:
a) 2,2-bis(bromomethyl)propane-1,3-diyl di (bromoacetate), 3-bromo-2-{[(bromoacetyl)oxy]methyl}-2-(bromomethyl)propyl hexanoate, and 2,2-bis(bromomethyl)propane-1,3-diyl dihexanoate;
b) (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate;
c) (2E)-2,3-dibromobut-2-ene-1,4-diyl dipropanoate, (2E)-2,3-dibromobut-2-ene-1,4-diyl bis(2-methylpropanoate), and (2E)-2,3-dibromo-4-[(propionyl)oxy]but-2-en-1-yl 2-methylpropanoate;
d) (2E)-2,3-dibromobut-2-ene-1,4-diyl bis(bromoacetate), (2E)-2,3-dibromo-4-[(bromoacetyl)oxy]but-2-en-1-yl hexanoate, and (2E)-2,3-dibromobut-2-ene-1,4-diyl dihexanoate;
e) (2E)-2,3-dibromobut-2-ene-1,4-diyl bis(2-methylpropanoate), (2E)-2,3-dibromobut-2-ene-1,4-diyl bis(bromoacetate), and (2E)-2,3-dibromo-4-[(bromoacetyl)oxy]but-2-en-1-yl 2-methylpropanoate;
f) (2E)-2,3-dibromobut-2-ene-1,4-diyl bis(2-methylpropanoate), (2E)-2,3-dibromobut-2-ene-1,4-diyl bis(3-methylbutanoate), and (2E)-2,3-dibromo-4-[(2-methylpropionyl)oxy]but-2-en-1-yl 3-methylbutanoate;
g) (2E)-2,3-dibromobut-2-ene-1,4-diyl dipropionate, (2E)-2,3-dibromobut-2-ene-1,4-diyl dilineolate, and (2E)-2,3-dibromo-4-[(propionyl)oxy]but-2-ene-1-yl lineolate;
h) (2E)-2,3-dibromobut-2-ene-1,4-diyl diacetate, (2E)-2,3-dibromobut-2-ene-1,4-diyl propionate, (2E)-2,3-dibromo-4-[(propionyl)oxy]but-2-en-1-yl acetate, (2Z)-but-2-ene-1,4-diyl diacetate, (2Z)-but-2-ene-1,4-diyl dipropionate, and (2Z)-1-[(propionyl)oxy]but-2-ene-4-yl acetate;
i) (2E)-2,3-dibromobut-2-ene-1,4-diyl diacetate, (2E)-2,3-dibromobut-2-ene-1,4-diyl di(2-methylpropanoate), (2E)-2,3-dibromo-4-[(2-methylpropionyl)oxy]but-2-en-1-yl acetate, (2Z)-but-2-ene-1,4-diyl diacetate, (2Z)-but-2-ene-1,4-diyl dipropionate, and (2Z)-1-[(2-methylpropionyl)oxy]but-2-ene-4-yl acetate;
j) (2E)-2,3-dibromobut-2-ene-1,4-diyl dibutanoate and 2,2-bis(bromomethyl)propane-1,3-diyl dibutanoate;
k) 2,2-bis(bromomethyl)propane-1,3-diyl diacetate, 2,2-bis(bromomethyl)propane-1,3-diyl dipropionate, 2,2-bis(bromomethyl)propane-1,3-diyl di(2-methylpropanoate), 3-bromo-2-{[acetyloxy]methyl}-2-(bromomethyl)propyl propionate, 3-bromo-2-{[acetyloxy]methyl}-2-(bromomethyl)propyl 2-methylpropanoate, 3-bromo-2-{[(propionyl)oxy]methyl}-2-(bromomethyl)propyl 2-methylpropanoate, (2E)-2,3-dibromobut-2-ene-1,4-diyl diacetate, (2E)-2,3-dibromobut-2-ene-1,4-diyl dipropionate, (2E)-2,3-dibromobut-2-ene-1,4-diyl di(2-methylpropanoate), (2E)-2,3-dibromo-4-[(2-methylpropionyl)oxy]but-2-en-1-yl acetate, (2E)-2,3-dibromo-4-[(2-methylpropionyl)oxy]but-2-en-1-yl propionate, and (2E)-2,3-dibromo-4-[(propionyl)oxy]but-2-en-1-yl acetate;
l) 2,2-bis(bromomethyl)propane-1,3-diyl dipropionate, 2,2-bis(bromomethyl)propane-1,3-diyl dibutyrate, 2,2-bis(bromomethyl)propane-1,3-diyl di(2-methylpropanoate), 3-bromo-2-{[(propionyl)oxy]methyl}-2-(bromomethyl)propyl butyrate, 3-bromo-2-[((propionyl)oxy)methyl]-2-(bromomethyl)propyl 2-methylpropanoate, 3-bromo-2-[(butyryloxy)methyl]-2-(bromomethyl)propyl 2-methylpropanoate, (2E)-2,3-dibromobut-2-ene-1,4-diyl dipropionate, (2E)-2,3-dibromobut-2-ene-1,4-diyl dibutyrate, (2E)-2,3-dibromobut-2-ene-1,4-diyl di(2-methylpropanoate), (2E)-2,3-dibromo-4-[(2-methylpropionyl)oxy]but-2-en-1-yl propionate, (2E)-2,3-dibromo-4-[(2-methylpropionyl)oxy]but-2-en-1-yl butyrate, and (2E)-2,3-dibromo-4-[(butyryl)oxy]but-2-en-1-yl propionate;
m) propane-1,2,3-triyl tris (bromoacetate), propane-1,2,3-triyl tris (hexanoate), propane-1,2,3-triyl bis(bromoacetate)(hexanoate), and propane-1,2,3-triyl (bromoacetate)bis(hexanoate).
   Preferred mixtures of diesters include b), c), g), and i) above, especially g). All of these mixtures can be used as liquid weighting agents in the practice of this invention. These mixtures can be prepared by including the alcohol and carboxylic acid components as reactants in one-pot syntheses. The mixtures of esters above are mixtures of saturated diesters; mixtures of unsaturated diesters; mixtures of saturated diesters and unsaturated diesters; and mixtures of saturated triesters. Preferred are mixtures of unsaturated diesters. These multi-ester mixtures provide lower melting points and better oil miscibility, especially at lower temperatures, as compared to the individual molecules of the mixtures.

Molecules in these mixtures, the diesters with different end groups, are new compositions of matter, specifically 3-bromo-2-{[(bromoacetyl)oxy]methyl}-2-(bromomethyl)propyl hexanoate, 3-bromo-2-{[acetyloxy]methyl}-2-(bromomethyl)propyl propionate, 3-bromo-2-{[acetyloxy]methyl}-2-(bromomethyl)propyl 2-methylpropanoate, 3-bromo-2-{[(propionyl)oxy]methyl}-2-(bromomethyl)propyl 2-methylpropanoate, 3-bromo-2-{[(propionyl)oxy]methyl}-2-(bromomethyl)propyl butyrate, 3-bromo-2-[(butyryloxy)methyl]-2-(bromomethyl)propyl 2-methylpropanoate, (2E)-2,3-dibromo-4-[(propionyl)oxy]but-2-en-1-yl butanoate, (2E)-2,3-dibromo-4-[(propionyl)oxy]but-2-en-1-yl 2-methylpropanoate, (2E)-2,3-dibromo-4-[(bromoacetyl)oxy]but-2-en-1-yl hexanoate, (2E)-2,3-dibromo-4-[(bromoacetyl)oxy]but-2-en-1-yl 2-methylpropanoate, (2E)-2,3-dibromo-4-[(2-methylpropionyl)oxy]but-2-en-1-yl 3-methylbutanoate, (2E)-2,3-dibromo-4-[(propionyl)oxy]but-2-ene-1-yl lineolate, (2E)-2,3-dibromo-4-[(propionyl)oxy]but-2-en-1-yl acetate, (2E)-2,3-dibromo-4-[(2-methylpropionyl)oxy]but-2-en-1-yl acetate, (2E)-2,3-dibromo-4-[(2-methylpropionyl)oxy]but-2-en-1-yl butyrate, (2Z)-1-[(propionyl)oxy]but-2-ene-4-yl acetate, (2Z)-1-[(2-methylpropionyl)oxy]but-2-ene-4-yl acetate, propane-1,2,3-triyl bis(bromoacetate)(hexanoate), and propane-1,2,3-triyl (bromoacetate)bis(hexanoate).

Other molecules in these mixtures, some of the diesters having the same end groups, are new compositions of matter, specifically 2,2-bis(bromomethyl)propane-1,3-diyl di (bromoacetate), 2,2-bis(bromomethyl)propane-1,3-diyl dibutanoate, (2E)-2,3-dibromobut-2-ene-1,4-diyl bis(bromoacetate), (2E)-2,3-dibromobut-2-ene-1,4-diyl dibutanoate, (2E)-2,3-dibromobut-2-ene-1,4-diyl bis(3-methylbutanoate), (2E)-2,3-dibromobut-2-ene-1,4-diyl dihexanoate, (2E)-2,3-dibromobut-2-ene-1,4-diyl dilineolate, (2Z)-but-2-ene-1,4-diyl diacetate, (2Z)-but-2-ene-1,4-diyl dipropionate, (2Z)-but-2-ene-1,4-diyl di(2-methylpropionate), and propane-1,2,3-triyl tris (bromoacetate).

The following examples are presented for purposes of illustration, and are not intended to impose limitations on the scope of this invention.

### Example 1

Several monoesters containing a 3-bromo-2,2-bis(bromomethyl)propyl group (often referred to as a tribromoneopentyl group), which contains a quaternary carbon atom, were prepared as follows.

Into a 500 mL round-bottom flask were charged pentaerythritol tribromide (tribromoneopentyl alcohol; 1.55 mol), the carboxylic acid (4.65 mol), p-toluenesulfonic acid monohydrate (12.30 g), and toluene (1.5 L). This mixture was heated to 114 to 117° C., and refluxed at these temperatures while collecting water in a Dean-Stark apparatus. The progress of the reaction was monitored by gas chromatography (GC). After a conversion of 98% or greater was observed, the reaction mixture was cooled to room temperature. The cooled reaction mixture was diluted with toluene (0.5 L) and then washed with saturated sodium bicarbonate (4×1 L). The phases were allowed to separate, and the separated organic layer was subjected to vacuum to remove the toluene to obtain the tribromoneopentyl esters as clear liquids in yields greater than 96%.

The tribromoneopentyl esters were each combined with a base oil in a 50:50 weight mixture. For most of the tribromoneopentyl esters, no solid formation or phase separation was observed in the oil/tribromoneopentyl ester mixtures after being kept at −18° C. for one week. Tribromoneopentyl propionate was tested at 0° C. and at −18° C., and phase separation was observed at both temperatures. Tribromoneopentyl butyrate was only tested at 0° C., but no solid formation or phase separation was observed after one week at that temperature.

Some of the tribromoneopentyl monoesters were tested in pairs in a base oil in a 25:25:50 weight ratio, with 25 wt % of each tribromoneopentyl monoester and 50 wt % of the base oil. A mixture containing tribromoneopentyl propionate and tribromoneopentyl hexanoate was miscible at room temperature, and no solid formation or phase separation was observed after one week at −18° C.

Table 1 summarizes some information for these molecules.

TABLE 1

| Run | Product | Density |
|---|---|---|
| 1 | tribromoneopentyl propionate | 1.87 g/mL |
| 2 | tribromoneopentyl butyrate | 1.79 g/mL |
| 3 | tribromoneopentyl 2-methylpropanoate | 1.79 g/mL |
| 4 | tribromoneopentyl valerate | 1.72 g/mL |
| 5 | tribromoneopentyl isovalerate | 1.73 g/mL |
| 6 | tribromoneopentyl hexanoate | 1.57 g/mL |

### Example 2

Several monoesters containing a 2,3-dibromoallyl group (also referred to as a 2,3-prop-2-enyl group), which contains a terminal alkene moiety, were prepared as follows.

Into a 500 mL round-bottom flask were charged dibromoallyl alcohol (2,3-dibromoprop-2-en-1-ol; 34.47 g, 0.15 mol), isobutyric acid (39.65 g, 0.45 mol), p-toluenesulfonic acid monohydrate (1.30 g) and toluene (250 mL). This mixture was stirred and heated to reflux, and maintained at reflux (116 to 118° C.) while stirring and collecting water in a Dean-Stark apparatus for 4 hours. The reaction mixture was then cooled to room temperature, and the cooled reaction mixture was washed with saturated sodium bicarbonate (5×80 mL), then dried with MgSO₄ and filtered. The liquid from the filtration was subjected to vacuum to remove the toluene, and 41.1 grams of the product were obtained as a clear liquid.

A very similar procedure was followed to form dibromoallyl propionate, except that propionic acid was used as the carboxylic acid, and the product yield was 40.6 grams as a clear liquid.

To form dibromoallyl acetate, a slightly different procedure was followed. Into a 500 mL round-bottom flask were charged with stirring under nitrogen dibromoallyl alcohol (45.2 g, 90% GC purity) and anhydrous dichloromethane (120 mL). Then triethylamine (23, 0.26 g) was added to the mixture, which was cooled to 0° C. while stirring. While keeping the mixture temperature below 4° C., acetyl chloride (16.4 g) was added from an addition funnel during 30 minutes. The reaction mixture was stirred at 4° C. for 2 hours after the acetyl chloride addition was finished, and then the reaction mixture was allowed to warm to room temperature. The reaction mixture was then diluted with dichloromethane (100 mL) and washed several times with water, then dried with MgSO₄ and filtered. The liquid from the filtration was subjected to vacuum to remove the dichloromethane, and 54.6 grams of liquid product were obtained.

The dibromoallyl esters were each combined with a base oil in a 50:50 weight mixture. For dibromoallyl propionate and dibromoallyl isobutyrate, no solid formation or phase separation was observed in the oil/dibromoallyl ester mixtures after being kept at −18° C. for one week. Dibromoallyl acetate was tested at 0° C., and no solid formation or phase separation was observed after one week at that temperature.

Table 2 summarizes some information for these molecules.

TABLE 2

| Run | Product | Density |
|---|---|---|
| 1 | 2,3-dibromoallyl acetate | 1.83 g/mL |
| 2 | 2,3-dibromoallyl propionate | 1.79 g/mL |
| 3 | 2,3-dibromoallyl 2-methylpropanoate | 1.70 g/mL |

Several mixtures of a monoester containing a terminal alkene moiety were tested in a base oil in a 50:50 weight mixture. For both 2,3-dibromoprop-2-en-1-yl propanoate and 2,3-dibromoprop-2-en-1-yl 2-methylpropanoate, the oil mixtures were miscible at room temperature, and no solid formation or phase separation was observed after one week at −18° C.

Several mixtures of a tribromoneopentyl monoester and a monoester containing a terminal alkene moiety were tested in a base oil in a 25:25:50 weight ratio, with 25 wt % of the tribromoneopentyl monoester, 25 wt % of 2,3-dibromoprop-2-en-1-yl propanoate, and 50 wt % of the base oil. When the tribromoneopentyl monoester was tribromoneopentyl propionate or tribromoneopentyl butyrate, the mixture was miscible at room temperature, and no solid formation or phase separation was observed after one week at −18° C. When the tribromoneopentyl monoester was tribromoneopentyl propionate or tribromoneopentyl butyrate and the monoester containing a terminal alkene moiety was 2,3-dibromoprop-2-en-1-yl 2-methylpropanoate, the mixture containing was miscible at room temperature, and no solid formation or phase separation was observed after one week at −18° C.

### Example 3

Several monoesters containing a (3,5-dibromophenyl)methyl group (also referred to as a 3,5-dibromobenzyl group), which contains an aromatic-alkyl moiety, were prepared as follows.

Into a 500 mL round-bottom flask were charged 3,5-dibrombenzyl alcohol (15.12 g, 0.057 mol), the carboxylic acid (0.11 mol), p-toluenesulfonic acid monohydrate (1.09 g), and toluene (250 mL). This mixture was heated to reflux and kept at 114° C. for 3 to 7 hours while collecting water in a Dean-Stark apparatus. The progress of the reaction was monitored by gas chromatography (GC). After the reaction appeared complete as indicated by GC, the reaction mixture was cooled to room temperature. The cooled reaction mixture was washed with saturated sodium bicarbonate (5×150 mL), then phase separated. The organic layer was dried with MgSO₄ and filtered. The liquid from the filtration. After filtration, toluene was removed from the organic layer on a rotary evaporator, followed by drying under high vacuum (~1 torr) to obtain a reddish liquid product.

Table 3 summarizes some information for these molecules.

TABLE 3

| Run | Product | Density |
|---|---|---|
| 1 | (3,5-dibromophenyl)methyl acetate | 1.76 g/mL |
| 2 | (3,5-dibromophenyl)methyl bromoacetate | 2.06 g/mL |
| 3 | (3,5-dibromophenyl)methyl propionate | 1.68 g/mL |
| 4 | (3,5-dibromophenyl)methyl butyrate | 1.62 g/mL |
| 5 | (3,5-dibromophenyl)methyl 2-methylpropanoate | 1.62 g/mL |
| 6 | (3,5-dibromophenyl)methyl pentanoate | 1.56 g/mL |

### Example 4

Several diesters containing a 2,2-bis(bromomethyl) 1,3-propanediol moiety, which contains a quaternary carbon atom, were prepared as follows.

Into a 500 mL round-bottom flask were charged 2,2-bis(bromomethyl) 1,3-propanediol (dibromoneopentyl glycol; 0.16 mol), the carboxylic acid (2 to 3 molar equivalents per alcohol hydroxy group), p-toluenesulfonic acid monohydrate (1.23 g), and toluene (0.15 L). This mixture was heated to 103 to 120° C., and refluxed at these temperatures while collecting water in a Dean-Stark apparatus. The progress of the reaction was monitored by GC. After a conversion of 98% or greater was observed (1 to 4.5 hours), the reaction mixture was cooled to room temperature. The cooled reaction mixture washed with saturated sodium bicarbonate (4×1 L). The phases were allowed to separate, and the separated organic layer was subjected to vacuum to remove the toluene to obtain the diesters as clear liquids in yields greater than 96%.

Table 4 summarizes some information for these molecules.

TABLE 4

| Run | Product | Density |
|---|---|---|
| 1 | 2,2-bis(bromomethyl)1,3-propanediol-1,3-dipropionate | 1.62 g/mL |
| 2 | 2,2-bis(bromomethyl)1,3-propanediol-1,3-di(2-methylpropanoate) | 1.46 g/mL |
| 3 | 2,2-bis(bromomethyl)1,3-propanediol-1,3-dihexanoate | 1.28 g/mL |
| 4 | 2,2-bis(bromomethyl)1,3-propanediol-1,3-bis-(bromoacetate) | 2.13 g/mL |

### Example 5

Several diesters containing a (2E)-2,3-dibromobut-2-ene-1,4-diyl group, which contains an internal alkene moiety, were prepared as follows. A diester containing a (2Z)-but-2-ene-1,4-diyl group, which contains an internal alkene moiety, was also prepared.

The procedure in Example 4 was followed, except that the alcohol was (2E)-2,3-dibromobut-2-ene-1,4-diol or (2Z)-but-2-ene-1,4-diol.

Table 5 summarizes some information for these molecules.

TABLE 5

| Run | Product | Density |
|---|---|---|
| 1 | (2E)-2,3-dibromobut-2-ene-1,4-diyl bis | 1.59 g/mL |
| | (propanoate) | |
| 2 | (2E)-2,3-dibromobut-2-ene-1,4-diyl bis | 1.49 g/mL |
| | (2-methylpropanoate) | |
| 3 | (2E)-2,3-dibromobut-2-ene-1,4-diyl bis | 1.94 g/mL |
| | (2′-bromobutyrate) | |
| 4 | (2Z)-but-2-ene-1,4-diyl bis(bromoacetate) | 1.74 g/mL |

### Example 6

Several mixtures of esters were synthesized. Into a flask were charged the mixture of alcohols (0.16 mol), the mixture of carboxylic acids (2 to 3 molar equivalents per alcohol hydroxy group), p-toluenesulfonic acid monohydrate (1.23 g), and toluene (0.25 L). This mixture was heated to 103 to 120° C., and refluxed at these temperatures while collecting water in a Dean-Stark apparatus. The progress of the reaction was monitored by GC. After a conversion of 98% or greater was observed, the reaction mixture was cooled to room temperature. The cooled reaction mixture was diluted with toluene (0.5 L) and then washed with saturated sodium bicarbonate (4×1 L). The phases were allowed to separate, and the separated organic layer was subjected to vacuum to remove the toluene to obtain the mixtures of ester products as clear liquids in yields greater than 96%. Table 6 summarizes some information for these mixture products.

TABLE 6

| Run | Products | Density |
|---|---|---|
| 1 | 2,2-bis(bromomethyl)propane-1,3-diyl di(bromoacetate) | 1.68 g/mL |
| | 3-bromo-2-{[(bromoacetyl)oxy]methyl}-2-(bromomethyl)propyl hexanoate | |
| | 2,2-bis(bromomethyl)propane-1,3-diyl dihexanoate | |
| 2 | (2E)-2,3-dibromobut-2-ene-1,4-diyl dipropanoate | 1.52 g/mL |
| | (2E)-2,3-dibromobut-2-ene-1,4-diyl dibutanoate | |
| | (2E)-2,3-dibromo-4-[(propionyl)oxy]but-2-en-1-yl butanoate | |
| 3 | (2E)-2,3-dibromobut-2-ene-1,4-diyl dipropanoate | 1.53 g/mL |
| | (2E)-2,3-dibromobut-2-ene-1,4-diyl bis(2-methylpropanoate) | |
| | (2E)-2,3-dibromo-4-[(propionyl)oxy]but-2-en-1-yl 2-methylpropanoate | |
| 4 | (2E)-2,3-dibromobut-2-ene-1,4-diyl bis(bromoacetate) | 1.72 g/mL |
| | (2E)-2,3-dibromo-4-[(bromoacetyl)oxy]but-2-en-1-yl hexanoate | |
| | (2E)-2,3-dibromobut-2-ene-1,4-diyl dihexanoate | |
| 5 | (2E)-2,3-dibromobut-2-ene-1,4-diyl bis(2-methylpropanoate) | 1.89 g/mL |
| | (2E)-2,3-dibromobut-2-ene-1,4-diyl bis(bromoacetate) | |
| | (2E)-2,3-dibromo-4-[(bromoacetyl)oxy]but-2-en-1-yl 2-methylpropanoate | |
| 6 | (2E)-2,3-dibromobut-2-ene-1,4-diyl bis(2-methylpropanoate) | 1.46 g/mL |
| | (2E)-2,3-dibromobut-2-ene-1,4-diyl bis(3-methylbutanoate) | |
| | (2E)-2,3-dibromo-4-[(2-methylpropionyl)oxy]but-2-en-1-yl 3-methylbutanoate | |
| 7 | (2E)-2,3-dibromobut-2-ene-1,4-diyl dipropionate | 1.06 g/mL |
| | (2E)-2,3-dibromobut-2-ene-1,4-diyl dilineolate | |
| | (2E)-2,3-dibromo-4-[(propionyl)oxy]but-2-ene-1-yl lineolate | |
| 8 | (2E)-2,3-dibromobut-2-ene-1,4-diyl diacetate | 1.54 g/mL |
| | (2E)-2,3-dibromobut-2-ene-1,4-diyl dipropionate | |
| | (2E)-2,3-dibromo-4-[(propionyl)oxy]but-2-en-1-yl acetate | |
| | (2Z)-but-2-ene-1,4-diyl diacetate | |
| | (2Z)-but-2-ene-1,4-diyl dipropionate | |
| | (2Z)-1-[(propionyl)oxy]but-2-ene-4-yl acetate | |
| 9 | (2E)-2,3-dibromobut-2-ene-1,4-diyl diacetate | 1.49 g/mL |
| | (2E)-2,3-dibromobut-2-ene-1,4-diyl di(2-methylpropanoate) | |
| | (2E)-2,3-dibromo-4-[(2-methylpropionyl)oxy]but-2-en-1-yl acetate | |
| | (2Z)-but-2-ene-1,4-diyl diacetate | |
| | (2Z)-but-2-ene-1,4-diyl di(2-methylpropionate) | |
| | (2Z)-1-[(2-methylpropionyl)oxy]but-2-ene-4-yl acetate | |
| 10 | (2E)-2,3-dibromobut-2-ene-1,4-diyl dibutanoate | 1.44 g/mL |
| | 2,2-bis(bromomethyl)propane-1,3-diyl dibutanoate | |
| 11 | 2,2-bis(bromomethyl)propane-1,3-diyl diacetate | 1.56 g/mL |
| | 2,2-bis(bromomethyl)propane-1,3-diyl dipropionate | |
| | 2,2-bis(bromomethyl)propane-1,3-diyl di(2-methylpropanoate) | |
| | 3-bromo-2-{[acetyloxy]methyl}-2-(bromomethyl)propyl propionate | |
| | 3-bromo-2-{[acetyloxy]methyl}-2-(bromomethyl)propyl 2-methylpropanoate | |
| | 3-bromo-2-{[(propionyl)oxy]methyl} -2-(bromomethyl)propyl 2-methylpropanoate | |
| | (2E)-2,3-dibromobut-2-ene-1,4-diyl diacetate | |
| | (2E)-2,3-dibromobut-2-ene-1,4-diyl dipropionate | |
| | (2E)-2,3-dibromobut-2-ene-1,4-diyl di(2-methylpropanoate) | |
| | (2E)-2,3-dibromo-4-[(2-methylpropionyl)oxy]but-2-en-1-yl acetate | |
| | (2E)-2,3-dibromo-4-[(2-methylpropionyl)oxy]but-2-en-1-yl propionate | |
| | (2E)-2,3-dibromo-4-[(propionyl)oxy]but-2-en-1-yl acetate | |
| 12 | 2,2-bis(bromomethyl)propane-1,3-diyl dipropionate | |
| | 2,2-bis(bromomethyl)propane-1,3-diyl dibutyrate | |
| | 2,2-bis(bromomethyl)propane-1,3-diyl di(2-methylpropanoate) | |
| | 3-bromo-2-{[(propionyl)oxy]methyl}-2-(bromomethyl)propyl butyrate | |
| | 3-bromo-2-[(propionyl)oxy)methyl]-2-(bromomethyl)propyl 2-methylpropanoate | |
| | 3-bromo-2-[(butyryloxy)methyl]-2-(bromomethyl)propyl 2-methylpropanoate | 1.51 g/mL |
| | (2E)-2,3-dibromobut-2-ene-1,4-diyl dipropionate | |
| | (2E)-2,3-dibromobut-2-ene-1,4-diyl dibutyrate | |
| | (2E)-2,3-dibromobut-2-ene-1,4-diyl di(2-methylpropanoate) | |
| | (2E)-2,3-dibromo-4-[(2-methylpropionyl)oxy]but-2-en-1-yl propionate | |
| | (2E)-2,3-dibromo-4-[(2-methylpropionyl)oxy]but-2-en-1-yl butyrate | |
| | (2E)-2,3-dibromo-4-[(butyryl)oxy]but-2-en-1-yl propionate | |
| 13 | propane-1,2,3-triyl tris(bromoacetate) | 1.54 g/mL |
| | propane-1,2,3-triyl tris(hexanoate) | |
| | propane-1,2,3-triyl bis(bromoacetate)(hexanoate) | |
| | propane-1,2,3-triyl (bromoacetate)bis(hexanoate) | |

### Example 7

A triester, propane-1,2,3-triyl tris (bromoacetate), was prepared according to the procedure in Example 4, except that the alcohol was glycerol, and 3 to 4 equivalents of bromoacetic acid were used. The density of propane-1,2,3-triyl tris (bromoacetate) was 1.95 g/mL.

### Testing Procedures

Admixture preparation. To a 600 ml beaker were added a synthetic oil fluid (Saraline® 185V), and a liquid weighting agent of the invention. An overhead lab mixer (Silverson, model L5M-A) is lowered into the liquid and slowly turned up to 4000 rpm. Various ingredients were then added sequentially, stirring for a period of time after each addition. The mixture was transferred to a stand mixer (Hamilton Beach), usually before the addition of calcium carbonate. When a liquid polymeric viscosifier was added, ice cubes were held against the outside of the Hamilton Beach stand mixer during the mixing of the liquid polymeric viscosifier to control the temperature because the standard procedure requires testing at room temperature (20 to 25° C.), and the mixing procedure usually increased the temperature to over 110° F. (43.3° C.). Sample components, amounts thereof, mixer type, and mixing time after each addition are summarized in the Tables below.

Admixture testing. The American Petroleum Institute Recommended Practice 13B-2 (API RP 13B-2) testing procedures for field testing oil-based drilling fluids were followed to obtain properties of the mixture formed as described above. The sample was then hot-rolled overnight to simulate heat aging of the sample in actual use. The properties of the sample were then tested again using the same testing procedures.

Fluid loss testing. The API Fluid Loss Experiment was conducted at approximately 250° F. (121° C.). The sample was heated to ~250° F. (121° C.) over 1.5 hours, and was passed through a 10-micron filter disk (Fann®) in a filter press (Model 387, Fann Instrument Company) at ~250° F. for 30 minutes with a 500 psi (3.45 MPa) pressure differential. The API fluid loss volume for fluid loss is double the total volume measured due to the surface area of the filter disk. The filter cake thickness was measured.

The HPHT fluid loss procedure was as follows:
1. A synthetic disk or rock core was placed into the testing cell.
2. The fluid to be tested was poured into the testing cell (typically 350 to 500 mL of fluid).
3. The testing cell was placed in a heating jacket and heated to the testing temperature (300° F. for most fluids).
4. A pressure, dependent on the testing temperature, was applied to the testing cell during heating of the testing cell.
5. Once the temperature has been reached, a pressure difference of 500 psi (3.45 MPa) was applied across the testing cell, and then valves were opened at both ends; the pressure difference pushed the fluid being tested through the synthetic disk or rock core.
6. The amount of fluid flowing through the disk was measured and recorded at various points in time.
7. The test continued for 30 minutes.
8. At the conclusion of the experiments the valves were closed, and the heating jacket was turned off. The testing cell was allowed to cool before removing the remaining fluid. Then the synthetic disk or rock core was removed and examined to observe the filter cake (solids left by the fluid as it traveled into or through the disk or rock core).

Sediment toxicity testing. Sediment toxicity testing was according to U.S. Environmental Protection Agency Method 1644, the “Method for Conducting a Sediment Toxicity Test with Leptocheirus plumulosus and Non-Aqueous Drilling Fluids or Synthetic-Based Drilling Muds”. The testing procedure was as follows:
1. Leptocheirus plumulosus amphipods were cultured and maintained in natural sediment at 23±2° C. before being exposed to a test sample.
2. A sample contained sediment, synthetic seawater, and the substance being tested. Five samples of each substance were prepared and tested, the sample having concentrations of 100, 200, 400, 800, and 1600 mg/kg of the substance to be tested.
3. For each sample, a 1-liter jar was prepared with approximately 150 mL of formulated sediment with 600 mL of synthetic sea water, and the substance to be tested.
4. In each test, 20 Leptocheirus plumulosus amphipods were exposed to the sample at 20±1° C. for 10 days in the 1-L closed jar; the Leptocheirus plumulosus amphipods were not fed after the test was initiated.
5. At the end of 10 days, the Leptocheirus plumulosus amphipods remaining alive were counted and an LC50 value was predicted based on those results. To pass this sediment toxicity test, the substance needs to have a higher LC50 than a C₁₆₋₁₈ internal olefin reference fluid.

Anaerobic biodegradation testing. The biodegradation test was a closed-bottle anaerobic test carried out for 275 days according to U.S. Environmental Protection Agency Method 1647. For each substance, four samples were run. Each test was compared to separate standard samples containing ethyl oleate, squalane, 1-hexadecene, C₁₆₋₁₈ internal olefin, or no additive. To pass the test, the sample must have more net biodegradation than the C₁₆₋₁₈ internal olefin. The testing procedure was as follows:
1. Each test mixture was prepared by combining with 2000 mg carbon (sample) per kg of natural sediment; 30 grams of the mixture were used for each sample run. The carbon content of the sample was measured before mixing the sample with the sediment. Synthetic sea water was added to bring the total volume in each sample bottles to 75 mL. The amount of carbon is 0.6 g (0.05 mol), which is expected to produce 112 mL of gas (CH₄ and CO₂) at standard temperature and pressure.
2. After a bottle was capped, a nitrogen sparge was employed to remove air in the headspace of the bottle before incubation was started.
3. During the incubation period, the sample is kept at a constant temperature of 29±1° C.
4. Gas production and composition were measured approximately every two weeks for 275 days (or until the experiment was stopped, if shorter than 275 days).
5. Each sample was brought to ambient temperature to make each measurement. Gas production was measured with a pressure gauge, and barometric pressure was also measured at the time of measurement to make volume corrections.

The components and testing results for a mixture containing (3-bromo-2,2-bis(bromomethyl)propyl 2-methylpropanoate are summarized in Tables A1-A3 below. The components are listed in the order added. The hot-rolling temperature was 105° C. The fluid loss filter cake had a 3/32-inch (0.238 cm) thickness, and the fluid loss test was conducted at 250° F. (121° C.).

TABLE A1

| Substance | Amount | Mixing time | Mixer |
|---|---|---|---|
| (3-bromo-2,2-bis(bromomethyl)propyl 2- | 114 mL | — | — |
| methylpropanoate | | | |
| C₉₋₂₁ hydrocarbons (synthetic oil fluid; | 114 mL | — | — |
| Saraline ® 185V) | | | |
| Sepiolite clay | 6 g | 30 min. | overhead |
| Hydrotreated light naphthenic distillates | 8 g | 5 min. | overhead |
| (Pexomul 936P) | | | |
| Tall oil fatty acids and hydrotreated light | 2 g | 5 min. | overhead |
| distillates (Pexomul 956P) | | | |
| organophilic derivative of bentonite clay | 1 g | 25 min. | overhead |
| (Bentone ® 150) | | | |
| Ca(OH)₂ (lime) | 5 g | 10 min. | overhead |
| CaBr₂ (aq., 14.2 ppg) | 129 g | 12 min. | overhead |
| CaCO₃ (Omya ® 04) | 51 g | 10 min. | stand |
| CaCO₃ (Omya ® 08) | 25.5 g | 10 min. | stand |
| CaCO₃ (Omya ® 15) | 8.5 g | 10 min. | stand |
| Ethoxylated alkylether sulfate, Na salt | 0.5 g | 10 min. | stand |
| (liquid polymeric viscosifier; Pexovis ® 553) | | | |

TABLE A2

| | | Run | | | |
|---|---|---|---|---|---|
| | | 1 | 2 | 3 | 4 |
| | | Before hot-rolling | | After hot-rolling | |
| | | Temperature | | | |
| | | 75° F. | 125° F. | 78° F. | 122° F. |
| | | (24° C.) | (51.7° C.) | (25.6° C.) | (50° C.) |
| Stirrer | Shear rate, | Shear | Shear | Shear | Shear |
| speed, RPM | Hz | stress | stress | stress | stress |
| 600 | 1022 | 166 | 93 | 163 | 92 |
| 300 | 511 | 108 | 58 | 99 | 56 |
| 200 | 341 | 88 | 44 | 76 | 42 |
| 100 | 170 | 60 | 30 | 50 | 28 |
| 6 | 10 | 25 | 12 | 16 | 10 |
| 3 | 5 | 22 | 11 | 14 | 9 |

| | | | | |
|---|---|---|---|---|
| Gel strength at 10 sec., | 26 | 15 | 15 | 10 |
| lb/100 ft² | | | | |
| Gel strength at 10 min., | 42 | 24 | 21 | 17 |
| lb/100 ft² | | | | |
| Electrical stability 1, V | 386 | 744 | 545 | 438 |
| Electrical stability 2, V | 389 | 741 | 453 | 440 |
| Plastic viscosity, cP | 58 | 35 | 64 | 36 |
| Yield Point, lb/100 ft² | 50 | 23 | 35 | 20 |

TABLE A3

| Sq. root | | Incremental | Cumulative | Fluid loss |
|---|---|---|---|---|
| of time | Time | loss | loss | (API volume) |
| 1 | 1 min. | 0.6 mL | 0.6 mL | 1.2 mL |
| 2.236068 | 5 min. | 1.3 mL | 1.9 mL | 3.8 mL |
| 2.738613 | 7.5 min. | 0.4 mL | 2.3 mL | 4.6 mL |
| 3.872983 | 15 min. | 1.2 mL | 3.5 mL | 7 mL |
| 4.472136 | 20 min. | 0.6 mL | 4.1 mL | 8.2 mL |
| 5.477226 | 30 min. | 0.5 mL | 4.6 mL | 9.2 mL |

Components and testing results for another mixture containing (3-bromo-2,2-bis(bromomethyl)propyl 2-methylpropanoate are summarized in Tables A4-A8 below. The components are listed in the order added. The hot-rolling temperature was 105° C. The fluid loss filter cake had a 3/32-inch (0.238 cm) thickness, and the fluid loss test was conducted at 250° F. (121° C.). A second hot rolling test was conducted, with a 7-day duration, followed by another fluid loss test.

TABLE A4

| Substance | Amount | Mixing time | Mixer |
|---|---|---|---|
| C₉₋₂₁ hydrocarbons (synthetic oil fluid; | 114 mL | — | — |
| Saraline ® 185V) | | | |
| Hydrotreated light naphthenic distillates | 8 g | 5 min. | overhead |
| (Pexomul 936P) | | | |
| Tall oil fatty acids and hydrotreated light | 2 g | 5 min. | overhead |
| distillates (Pexomul 956P) | | | |
| CaBr₂ (aq., 14.2 ppg) | 129 g | 10 min. | overhead |
| (3-bromo-2,2-bis(bromomethyl)propyl | 114 mL | 10 min. | overhead |
| 2-methylpropanoate | | | |
| Ca(OH)₂ (lime) | 5 g | 10 min. | overhead |
| Sepiolite clay | 6 g | 10 min. | overhead |
| organophilic derivative of bentonite clay | 1 g | 10 min. | overhead |
| (Bentone ® 150) | | | |
| CaCO₃ (Omya ® 04) | 51 g | 10 min. | stand |
| CaCO₃ (Omya ® 08) | 25.5 g | 10 min. | stand |
| CaCO₃ (Omya ® 15) | 8.5 g | 10 min. | stand |
| Ethoxylated alkylether sulfate, Na salt | 0.5 g | 10 min. | stand |
| (liquid polymeric viscosifier; Pexovis ® 553) | | | |

TABLE A5

| | | Run | | | |
|---|---|---|---|---|---|
| | | 1 | 2 | 3 | 4 |
| | | Before hot-rolling | | After hot-rolling | |
| | | Temperature | | | |
| | | 76° F. | 124° F. | 71° F. | 122° F. |
| | | (24.4° C.) | (51.1° C.) | (21.7° C.) | (50° C.) |
| Stirrer | Shear rate, | Shear | Shear | Shear | Shear |
| speed, RPM | Hz | stress | stress | stress | stress |
| 600 | 1022 | 157 | 82 | 162 | 81 |
| 300 | 511 | 98 | 51 | 96 | 49 |
| 200 | 341 | 75 | 40 | 72 | 38 |
| 100 | 170 | 50 | 28 | 46 | 25 |
| 6 | 10 | 19 | 13 | 14 | 9 |
| 3 | 5 | 17 | 12 | 12 | 8 |

| | | | | |
|---|---|---|---|---|
| Gel strength at 10 sec., | 22 | 15 | 13 | 10 |
| lb/100 ft² | | | | |
| Gel strength at 10 min., | 30 | 26 | 18 | 15 |
| lb/100 ft² | | | | |
| Electrical stability 1, V | 412 | 535 | 453 | 399 |
| Electrical stability 2, V | 418 | 525 | 457 | 404 |
| Plastic viscosity, cP | 59 | 31 | 66 | 32 |
| Yield Point, lb/100 ft² | 39 | 20 | 30 | 17 |

TABLE A6

| Sq. root | | Incremental | Cumulative | Fluid loss |
|---|---|---|---|---|
| of time | Time | loss | loss | (API volume) |
| 1 | 1 min. | 0.7 mL | 0.7 mL | 1.4 mL |
| 2.236068 | 5 min. | 1.3 mL | 2 mL | 4 mL |
| 2.738613 | 7.5 min. | 0.7 mL | 2.7 mL | 5.4 mL |
| 3.872983 | 15 min. | 1.2 mL | 3.9 mL | 7.8 mL |
| 4.472136 | 20 min. | 0.7 mL | 4.6 mL | 9.2 mL |
| 5 | 25 min. | 0.7 mL | 5.3 mL | 10.6 mL |
| 5.477226 | 30 min. | 0.7 mL | 6 mL | 12 mL |

TABLE A7

| | | Run | | | |
|---|---|---|---|---|---|
| | | 1 | 2 | 3 | 4 |
| | | 7-day test | | | |
| | | Before hot-rolling | | After hot-rolling | |
| | | Temperature | | | |
| | | 77° F. | 122° F. | 72° F. | 123° F. |
| | | (25°C) | (50° C.) | (22.2° C.) | (50.6° C.) |
| Stirrer | Shear rate, | Shear | Shear | Shear | Shear |
| speed, RPM | Hz | stress | stress | stress | stress |
| 600 | 1022 | 179 | 101 | 227 | 113 |
| 300 | 511 | 115 | 63 | 140 | 70 |
| 200 | 341 | 90 | 50 | 108 | 55 |
| 100 | 170 | 61 | 35 | 68 | 37 |
| 6 | 10 | 25 | 17 | 20 | 15 |
| 3 | 5 | 23 | 16 | 18 | 14 |

| | | | | |
|---|---|---|---|---|
| Gel strength at 10 sec., | 27 | 19 | 21 | 17 |
| lb/100 ft² | | | | |
| Gel strength at 10 min., | 42 | 30 | 33 | 31 |
| lb/100 ft² | | | | |
| Electrical stability 1, V | 484 | 523 | — | 380 |
| Electrical stability 2, V | 488 | 516 | — | 372 |
| Plastic viscosity, cP | | | | |
| Yield Point, lb/100 ft² | 51 | 25 | 53 | 27 |

TABLE A8

| Sq. root | | Incremental | Cumulative | Fluid loss |
|---|---|---|---|---|
| of time | Time | loss | loss | (API volume) |
| 1 | 1 min. | 1.9 mL | 1.9 mL | 3.8 mL |
| 2.236068 | 5 min. | 2.3 mL | 4.2 mL | 8.4 mL |
| 2.738613 | 7.5 min. | 1 mL | 5.2 mL | 10.4 mL |
| 3.872983 | 15 min. | 1.8 mL | 7 mL | 14 mL |
| 4.472136 | 20 min. | 2 mL | 9 mL | 18 mL |
| 5 | 25 min. | 1.1 mL | 10.1 mL | 20.2 mL |
| 5.477226 | 30 min. | 1 mL | 11.1 mL | 22.2 mL |

Components and testing results for another mixture containing (3-bromo-2,2-bis(bromomethyl)propyl 2-methylpropanoate are summarized in Tables A9-A11 below. The components are listed in the order added. The hot-rolling temperature was 105° C. The fluid loss filter cake had a 3/32-inch (0.238 cm) thickness, and the fluid loss test was conducted at 250° F. (121° C.).

TABLE A9

| Substance | Amount | Mixing time | Mixer |
|---|---|---|---|
| (3-bromo-2,2-bis(bromomethyl)propyl 2- | 114 mL | — | — |
| methylpropanoate | | | |
| C₉₋₂₁ hydrocarbons (synthetic oil fluid; | 114 mL | — | — |
| Saraline ® 185V) | | | |
| Sepiolite clay | 6 g | 30 min. | overhead |
| Hydrotreated light naphthenic distillates | 8 g | 5 min. | overhead |
| (Pexomul 936P) | | | |
| Tall oil fatty acids and hydrotreated light | 2 g | 5 min. | overhead |
| distillates (Pexomul 956P) | | | |
| organophilic derivative of bentonite clay | 1 g | 25 min. | overhead |
| (Bentone ® 150) | | | |
| Ca(OH)₂ (lime) | 5 g | 10 min. | overhead |
| CaBr₂ (aq., 14.2 ppg) | 129 g | 12 min. | overhead |
| CaCO₃ (Omya ® 04) | 51 g | 10 min. | stand |
| CaCO₃ (Omya ® 08) | 25.5 g | 10 min. | stand |
| CaCO₃ (Omya ® 15) | 8.5 g | 10 min. | stand |
| Ethoxylated alkylether sulfate, Na salt | 0.5 g | 10 min. | stand |
| (liquid polymeric viscosifier; Pexovis ® 553) | | | |

TABLE A10

| | | Run | | | |
|---|---|---|---|---|---|
| | | 1 | 2 | 3 | 4 |
| | | Before hot-rolling | | After hot-rolling | |
| | | Temperature | | | |
| | | 75° F. | 125° F. | 78° F. | 122° F. |
| | | (24° C.) | (51.7° C.) | (25.6° C.) | (50° C.) |
| Stirrer | Shear rate, | Shear | Shear | Shear | Shear |
| speed, RPM | Hz | stress | stress | stress | stress |
| 600 | 1022 | 166 | 93 | 163 | 92 |
| 300 | 511 | 108 | 58 | 99 | 56 |
| 200 | 341 | 88 | 44 | 76 | 42 |
| 100 | 170 | 60 | 30 | 50 | 28 |
| 6 | 10 | 25 | 12 | 16 | 10 |
| 3 | 5 | 22 | 11 | 14 | 9 |

| | | | | |
|---|---|---|---|---|
| Gel strength at 10 sec., | 26 | 15 | 15 | 10 |
| lb/100 ft² | | | | |
| Gel strength at 10 min., | 42 | 24 | 21 | 17 |
| lb/100 ft² | | | | |
| Electrical stability 1, V | 386 | 744 | 545 | 438 |
| Electrical stability 2, V | 389 | 741 | 453 | 440 |
| Plastic viscosity, cP | 58 | 35 | 64 | 36 |
| Yield Point, lb/100 ft² | 50 | 23 | 35 | 20 |

TABLE A11

| Sq. root | | Incremental | Cumulative | Fluid loss |
|---|---|---|---|---|
| of time | Time | loss | loss | (API volume) |
| 1 | 1 min. | 0.6 mL | 0.6 mL | 1.2 mL |
| 2.236068 | 5 min. | 1.3 mL | 1.9 mL | 3.8 mL |
| 2.738613 | 7.5 min. | 0.4 mL | 2.3 mL | 4.6 mL |
| 3.872983 | 15 min. | 1.2 mL | 3.5 mL | 7 mL |
| 4.472136 | 20 min. | 0.6 mL | 4.1 mL | 8.2 mL |
| 5.477226 | 30 min. | 0.5 mL | 4.6 mL | 9.2 mL |

Components and testing results for another mixture containing (3-bromo-2,2-bis(bromomethyl)propyl 2-methylpropanoate are summarized in Tables A12-A14 below. The components are listed in the order added. The hot-rolling temperature was 105° C. The fluid loss filter cake had a 4/32-inch (0.32 cm) thickness, and the fluid loss test was conducted at 250° F. (121° C.).

TABLE A12

| | | Mixing | |
|---|---|---|---|
| Substance | Amount | time | Mixer |
| (3-bromo-2,2-bis(bromomethyl)propyl 2- | 114 mL | — | — |
| methylpropanoate | | | |
| C₉₋₂₁ hydrocarbons (synthetic oil fluid; | 114 mL | 5 min. | overhead |
| Saraline ® 185V) | | | |
| Hydrotreated light naphthenic distillates | 8 g | 5 min. | overhead |
| (Pexomul 936P) | | | |
| Tall oil fatty acids and hydrotreated light | 2 g | 5 min. | overhead |
| distillates (Pexomul 956P) | | | |
| CaBr₂ (aq., 14.2 ppg) | 129 g | 10 min. | overhead |
| Ca(OH)₂ (lime) | 5 g | 10 min. | overhead |
| Sepiolite clay | 3 g | 10 min. | overhead |
| organophilic derivative of bentonite clay | 1 g | 10 min. | overhead |
| (Bentone ® 150) | | | |
| CaCO₃ (Omya ® 04) | 51 g | 10 min. | stand |
| CaCO₃ (Omya ® 08) | 25.5 g | 10 min. | stand |
| CaCO₃ (Omya ® 15) | 8.5 g | 10 min. | stand |
| Ethoxylated alkylether sulfate, Na salt | 0.5 g | 10 min. | stand |
| (liquid polymeric viscosifier; | | | |
| Pexovis ® 553) | | | |

TABLE A13

| | | Run | | | |
|---|---|---|---|---|---|
| | | 1 | 2 | 3 | 4 |
| | | Before hot-rolling | | After hot-rolling | |
| | | Temperature | | | |
| | | 75° F. | 125° F. | 78° F. | 122° F. |
| | | (24° C.) | (51.7° C.) | (25.6° C.) | (50° C.) |
| Stirrer | Shear rate, | Shear | Shear | Shear | Shear |
| speed, RPM | Hz | stress | stress | stress | stress |
| 600 | 1022 | 132 | 65 | 131 | 71 |
| 300 | 511 | 80 | 38 | 77 | 41 |
| 200 | 341 | 61 | 29 | 57 | 31 |
| 100 | 170 | 38 | 18 | 34 | 19 |
| 6 | 10 | 12 | 7 | 9 | 6 |
| 3 | 5 | 10 | 6 | 7 | 5 |

| | | | | |
|---|---|---|---|---|
| Gel strength at 10 sec., | 13 | 8 | 8 | 6 |
| lb/100 ft² | | | | |
| Gel strength at 10 min., | 19 | 18 | 12 | 10 |
| lb/100 ft² | | | | |
| Electrical stability 1, V | 322 | 427 | 256 | 204 |
| Electrical stability 2, V | 311 | 437 | 249 | 196 |
| Plastic viscosity, cP | 52 | 27 | 54 | 30 |
| Yield Point, lb/100 ft² | 28 | 11 | 23 | 11 |

TABLE A14

| Sq. root | | Incremental | Cumulative | Fluid loss |
|---|---|---|---|---|
| of time | Time | loss | loss | (API volume) |
| 1 | 1 min. | 2.2 mL | 2.2 mL | 4.4 mL |
| 2.236068 | 5 min. | 6.1 mL | 8.3 mL | 16.6 mL |
| 2.738613 | 7.5 min. | 3.3 mL | 11.6 mL | 23.2 mL |
| 3.872983 | 15 min. | 5.8 mL | 17.4 mL | 34.8 mL |
| 4.472136 | 20 min. | 2.9 mL | 20.3 mL | 40.6 mL |
| 5 | 25 min. | 2.7 mL | 23 mL | 46 mL |
| 5.477226 | 30 min. | 2.9 mL | 25.9 mL | 51.8 mL |

Components and testing results for another two mixtures containing (3-bromo-2,2-bis(bromomethyl)propyl 2-methylpropanoate are summarized in Tables A15-A19 below. The components are listed in the order added; two batches of this mixture of components were prepared. The hot-rolling temperature was 105° C. The fluid loss tests were conducted at 250° F. (121° C.). For the first mixture (Table A17), the fluid loss filter cake had a 3/32-inch (0.238 cm) thickness.

TABLE A15

| | | Mixing | |
|---|---|---|---|
| Substance | Amount | time | Mixer |
| (3-bromo-2,2-bis(bromomethyl)propyl | 114 mL | — | — |
| 2-methylpropanoate | | | |
| C₉₋₂₁ hydrocarbons (synthetic oil fluid; | 114 mL | — | — |
| Saraline ® 185V) | | | |
| Sepiolite clay | 6 g | 20 min. | overhead |
| Hydrotreated light naphthenic distillates | 8 g | 5 min. | overhead |
| (Pexomul 936P) | | | |
| Tall oil fatty acids and hydrotreated light | 2 g | 5 min. | overhead |
| distillates (Pexomul 956P) | | | |
| organophilic derivative of bentonite clay | 1 g | 15 min. | overhead |
| (Bentone ® 150) | | | |
| Ca(OH)₂ (lime) | 5 g | 10 min. | overhead |
| CaCl₂ 2H₂O | 34.5 g | 10 min. | overhead |
| H₂O | 60 g | 10 min. | overhead |
| CaCO₃ (Omya ® 04) | 42.5 g | 10 min. | stand |
| CaCO₃ (Omya ® 08) | 42.5 g | 10 min. | stand |
| Ethoxylated alkylether sulfate, Na salt | 0.5 g | 10 min. | stand |
| (liquid polymeric viscosifier; | | | |
| Pexovis ® 553) | | | |

TABLE A16

| | | Run | | | |
|---|---|---|---|---|---|
| | | 1 | 2 | 3 | 4 |
| | | Before hot-rolling | | After hot-rolling | |
| | | Temperature | | | |
| | | 75° F. | 117° F. | 69° F. | 120° F. |
| | | (24° C.) | (47.2° C.) | (20.6° C.) | (49° C.) |
| Stirrer | Shear rate, | Shear | Shear | Shear | Shear |
| speed, RPM | Hz | stress | stress | stress | stress |
| 600 | 1022 | 162 | 106 | 210 | 108 |
| 300 | 511 | 110 | 71 | 125 | 68 |
| 200 | 341 | 89 | 59 | 97 | 52 |
| 100 | 170 | 65 | 44 | 61 | 35 |
| 6 | 10 | 27 | 21 | 16 | 14 |
| 3 | 5 | 27 | 21 | 18 | 15 |

| | | | | |
|---|---|---|---|---|
| Gel strength at 10 sec., | 27 | 21 | 18 | 15 |
| lb/100 ft² | | | | |
| Electrical stability 1, V | 512 | 589 | 430 | 487 |
| Electrical stability 2, V | 502 | 572 | 437 | 475 |
| Plastic viscosity, cP | 52 | 35 | 85 | 40 |
| Yield Point, lb/100 ft² | 58 | 36 | 40 | 28 |

TABLE A17

| Sq. root | | Incremental | Cumulative | Fluid loss |
|---|---|---|---|---|
| of time | Time | loss | loss | (API volume) |
| 1 | 1 min. | 0 mL | 0 mL | 0 mL |
| 2.236068 | 5 min. | 0.6 mL | 0.6 mL | 1.2 mL |
| 2.738613 | 7.5 min. | 0.5 mL | 1.1 mL | 2.2 mL |
| 3.872983 | 15 min. | 1 mL | 2.1 mL | 4.2 mL |
| 4.472136 | 20 min. | 0.7 mL | 2.8 mL | 5.6 mL |
| 5 | 25 min. | 0.6 mL | 3.4 mL | 6.8 mL |
| 5.477226 | 30 min. | 0.6 mL | 4 mL | 8 mL |

Test results for the second mixture are as follows. For this mixture (Table A19), the fluid loss filter cake had a 6/32-inch (0.476 cm) thickness.

TABLE A18

| | | Run | | | |
|---|---|---|---|---|---|
| | | 1 | 2 | 3 | 4 |
| | | Before hot-rolling | | After hot-rolling | |
| | | Temperature | | | |
| | | 74° F. | 117° F. | 85° F. | 122° F. |
| | | (23.3° C.) | (47.2° C.) | (29.4° C.) | (50° C.) |
| Stirrer | Shear rate, | Shear | Shear | Shear | Shear |
| speed, RPM | Hz | stress | stress | stress | stress |
| 600 | 1022 | 156 | 95 | 237 | 153 |
| 300 | 511 | 106 | 66 | 1511 | 103 |
| 200 | 341 | 86 | 54 | 119 | 85 |
| 100 | 170 | 62 | 41 | 79 | 60 |
| 6 | 10 | 26 | 20 | 32 | 31 |
| 3 | 5 | 23 | 19 | 28 | 29 |

| | | | | |
|---|---|---|---|---|
| Gel strength at 10 sec., | 25 | 20 | 31 | 29 |
| lb/100 ft² | | | | |
| Gel strength at 10 min., | 31 | 24 | 41 | 33 |
| lb/100 ft² | | | | |
| Electrical stability 1, V | 492 | 526 | 430 | 649 |
| Electrical stability 2, V | 487 | 509 | 681 | 621 |
| Plastic viscosity, cP | 50 | 29 | 86 | 50 |
| Yield Point, lb/100 ft² | 56 | 37 | 65 | 53 |

TABLE A19

| Sq. root | | Incremental | Cumulative | Fluid loss |
|---|---|---|---|---|
| of time | Time | loss | loss | (API volume) |
| 1 | 1 min. | 2.6 mL | 2.6 mL | 5.2 mL |
| 2.236068 | 5 min. | 3.4 mL | 6 mL | 12 mL |
| 2.738613 | 7.5 min. | 3 mL | 9 mL | 18 mL |
| 3.872983 | 15 min. | 3.7 mL | 12.7 mL | 25.4 mL |
| 4.472136 | 20 min. | 1.9 mL | 14.6 mL | 29.2 mL |
| 5 | 25 min. | 2.1 mL | 16.7 mL | 33.4 mL |
| 5.477226 | 30 min. | 2.2 mL | 18.9 mL | 37.8 mL |

Components and testing results for another mixture containing (3-bromo-2,2-bis(bromomethyl)propyl 2-methylpropanoate are summarized in Tables A20-A22 below. The components are listed in the order added. The hot-rolling temperature was 105° C. The fluid loss filter cake had a 4/32-inch (0.32 cm) thickness, and the fluid loss test was conducted at 250° F. (121° C.).

TABLE A20

| | | Mixing | |
|---|---|---|---|
| Substance | Amount | time | Mixer |
| (3-bromo-2,2-bis(bromomethyl)propyl | 114 mL | — | — |
| 2-methylpropanoate | | | |
| C₉₋₂₁ hydrocarbons (synthetic oil fluid; | 114 mL | — | — |
| Saraline ® 185V) | | | |
| Sepiolite clay | 6 g | 20 min. | overhead |
| Hydrotreated light naphthenic distillates | 16 g | 5 min. | overhead |
| (Pexomul 936P) | | | |
| Tall oil fatty acids and hydrotreated | 4 g | 5 min. | overhead |
| light distillates (Pexomul 956P) | | | |
| Ca(OH)₂ (lime) | 5 g | 20 min. | overhead |
| CaCl₂ 2H₂O | 34.5 g | 20 min. | overhead |
| H₂O | 60 g | 20 min. | overhead |
| CaCO₃ (Omya ® 04) | 51 g | 10 min. | stand |
| CaCO₃ (Omya ® 08) | 25 g | 10 min. | stand |
| CaCO₃ (Omya ® 15) | 8.5 g | 10 min. | stand |

TABLE A21

| | | Run | | | |
|---|---|---|---|---|---|
| | | 1 | 2 | 3 | 4 |
| | | Before hot-rolling | | After hot-rolling | |
| | | Temperature | | | |
| | | 83° F. | 125° F. | 86° F. | 112° F. |
| | | (28.3° C.) | (51.7° C.) | (30° C.) | (44.4° C.) |
| Stirrer | Shear rate, | Shear | Shear | Shear | Shear |
| speed, RPM | Hz | stress | stress | stress | stress |
| 600 | 1022 | 112 | 62 | 117 | 66 |
| 300 | 511 | 72 | 39 | 66 | 38 |
| 200 | 341 | 56 | 31 | 48 | 27 |
| 100 | 170 | 37 | 21 | 29 | 17 |
| 6 | 10 | 1 | 7 | 7 | 6 |
| 3 | 5 | 8 | 6 | 6 | 5 |

| | | | | |
|---|---|---|---|---|
| Gel strength at 10 sec., | 11 | 9 | 9 | 7 |
| lb/100 ft² | | | | |
| Gel strength at 10 min., | 14 | 11 | 9 | 8 |
| lb/100 ft² | | | | |
| Electrical stability 1, V | 236 | 230 | 259 | 259 |
| Electrical stability 2, V | 225 | 235 | 242 | 255 |
| Plastic viscosity, cP | 40 | 23 | 51 | 28 |
| Yield Point, lb/100 ft² | 32 | 16 | 15 | 10 |

TABLE A22

| Sq. root | | Incremental | Cumulative | Fluid loss |
|---|---|---|---|---|
| of time | Time | loss | loss | (API volume) |
| 1 | 1 min. | 0 mL | 0 mL | 0 mL |
| 2.236068 | 5 min. | 0.7 mL | 0.7 mL | 1.4 mL |
| 2.738613 | 7.5 min. | 0.2 mL | 0.9 mL | 1.8 mL |
| 3.872983 | 15 min. | 1.1 mL | 2 mL | 4 mL |
| 4.472136 | 20 min. | 0.6 mL | 2.6 mL | 5.2 mL |
| 5 | 25 min. | 0.7 mL | 3.3 mL | 6.5 mL |
| 5.477226 | 30 min. | 0.5 mL | 3.8 mL | 7.6 mL |

Components and testing results for another mixture containing (3-bromo-2,2-bis(bromomethyl)propyl 2-methylpropanoate are summarized in Tables A23-A24 below. The components are listed in the order added. The shear stress test was performed, but the mixture was not subjected to hot rolling.

TABLE A23

| Substance | Amount | Mixing time | Mixer |
|---|---|---|---|
| (3-bromo-2,2-bis(bromomethyl)propyl | 160 mL | — | — |
| 2-methylpropanoate | | | |
| C₉₋₂₁ hydrocarbons (synthetic oil fluid; | 160 mL | — | — |
| Saraline ® 185V) | | | |
| Sepiolite clay | 6 g | 30 min. | overhead |
| CaCO₃ (Omya ® 04) | 51 g | 20 min. | stand |
| CaCO₃ (Omya ® 08) | 25 g | 20 min. | stand |
| CaCO₃ (Omya ® 15) | 8.5 g | 20 min. | stand |

TABLE A24

| | | Run | |
|---|---|---|---|
| | | 1 | 2 |
| | | No hot-rolling | |
| | | Temperature | |
| | | 74° F. | 123° F. |
| | | (23.3° C.) | (50.6° C.) |
| Stirrer | Shear rate, | Shear | Shear |
| speed, RPM | Hz | stress | stress |
| 600 | 1022 | 41 | 21 |
| 300 | 511 | 24 | 13 |
| 200 | 341 | 18 | 10 |
| 100 | 170 | 12 | 7 |
| 6 | 10 | 4 | 3 |
| 3 | 5 | 3 | 3 |

| | | |
|---|---|---|
| Gel strength at 10 sec., | 5 | 4 |
| lb/100 ft² | | |
| Gel strength at 10 min., | 5 | 4 |
| lb/100 ft² | | |
| Plastic viscosity, cP | 17 | 8 |
| Yield Point, lb/100 ft² | 7 | 5 |

The components and testing results for a mixture containing (2E)-2,3-dibromobut-2-ene-1,4-diyl bis(2-methylpropanoate) are summarized in Tables B1-B2 below. The components are listed in the order added. The hot-rolling temperature was 105° C.

TABLE B1

| | | Mixing | |
|---|---|---|---|
| Substance | Amount | time | Mixer |
| (2E)-2,3-dibromobut-2-ene-1,4-diyl bis(2- | 115 mL | — | — |
| methylpropanoate) | | | |
| C₉₋₂₁ hydrocarbons (synthetic oil fluid; | 115 mL | — | — |
| Saraline ® 185V) | | | |
| organic derivative of hectorite clay | 3 g | 25 min. | overhead |
| (Bentone ® 38) | | | |
| Hydrotreated tall oil distillate | 8 g | 10 min. | overhead |
| (AES MULX) | | | |
| Hydrotreated tall oil distillate | 3 g | 10 min. | overhead |
| (AES MULX) | | | |
| Dipropylene glycol monomethyl ether | 1 g | 10 min. | overhead |
| (Thixatrol ® DW50) | | | |
| Ca(OH)₂ (lime) | 5 g | 10 min. | overhead |
| CaBr₂ (aq., 14.2 ppg) | 119 g | 10 min. | overhead |
| H₂O | 6 g | 10 min. | overhead |
| CaCO₃ (Omya ® 04) | 45 g | 1 min. | stand |
| CaCO₃ (Omya ® 08) | 30 g | 1 min. | stand |
| CaCO₃ (Omya ® 15) | 10 g | 1 min. | stand |
| Ethoxylated alkylether sulfate, Na salt | 0.5 g | 18 min. | stand |
| (Pexovis ® 553) | | | |

TABLE B2

| | | Run | | | |
|---|---|---|---|---|---|
| | | 1 | 2 | 3 | 4 |
| | | Before hot-rolling | | After hot-rolling | |
| | | Temperature | | | |
| | | 67° F. | 146°F | 71° F. | 146°F |
| | | (19.4° C.) | (63.3° C.) | (21.7° C.) | (63.3° C.) |
| Stirrer | Shear rate, | Shear | Shear | Shear | Shear |
| speed, RPM | Hz | stress | stress | stress | stress |
| 600 | 1022 | 73 | 68 | 114 | 44 |
| 300 | 511 | 44 | 46 | 67 | 28 |
| 200 | 341 | 33 | 36 | 52 | 22 |
| 100 | 170 | 21 | 25 | 34 | 16 |
| 6 | 10 | 8 | 14 | 11 | 6 |
| 3 | 5 | 7 | 12 | 9 | 5 |

| | | | | |
|---|---|---|---|---|
| Gel strength at 10 sec., | 8 | 18 | 11 | 7 |
| lb/100 ft² | | | | |
| Gel strength at 10 min., | 17 | 23 | 23 | 10 |
| lb/100 ft² | | | | |
| Electrical stability, V* | 707 | 660 | 160 | 133 |
| Plastic viscosity, cP | 29 | 22 | 47 | 16 |
| Yield Point, lb/100 ft² | 15 | 24 | 20 | 12 |

*Reported values are an average of two runs.

Components and testing results for another mixture containing (2E)-2,3-dibromobut-2-ene-1,4-diyl bis(2-methylpropanoate) are summarized in Tables B3-B4 below. The components are listed in the order added. The hot-rolling temperature was 149° C.

TABLE B3

| Substance | Amount | | Mixing time | | Mixer |
|---|---|---|---|---|---|
| (2E)-2,3-dibromobut-2-ene-1,4-diyl | 115 | mL | — | | — |
| bis(2-methylpropanoate) | | | | | |
| C₉₋₂₁ hydrocarbons (synthetic oil fluid) | 115 | mL | — | | — |
| (Saraline ® 185V) | | | | | |
| organic derivative of hectorite clay | 3 | g | 30 | min. | overhead |
| (Bentone ® 38) | | | | | |
| Hydrotreated tall oil distillate | 8 | g | 10 | min. | overhead |
| (AES MULX) | | | | | |
| Hydrotreated tall oil distillate | 3 | g | 10 | min. | overhead |
| (AES MULX) | | | | | |
| Dipropylene glycol monomethyl ether | 1 | g | 10 | min. | overhead |
| (Thixatrol ® DW50) | | | | | |
| Ca(OH)₂ (lime) | 5 | g | 10 | min. | overhead |
| CaBr₂ (aq., 14.2 ppg) | 119 | g | 10 | min. | overhead |
| H₂O | 6 | g | 10 | min. | overhead |
| CaCO₃ (Omya ® 04) | 45 | g | 1 | min. | stand |
| CaCO₃ (Omya ® 08) | 30 | g | 1 | min. | stand |
| CaCO₃ (Omya ® 15) | 15 | g | 1 | min. | stand |
| Ethoxylated alkylether sulfate, Na salt | 1 | g | 18 | min. | stand |
| (liquid polymeric viscosifier; | | | | | |

Pexovis ® 553)

TABLE B4

| | | Run | | | |
|---|---|---|---|---|---|
| | | 1 | 2 | 3 | 4 |
| | | Before hot-rolling | | After hot-rolling | |
| | | Temperature | | | |
| | | 67° F. | 146° F. | 71° F. | 146° F. |
| | | (19.4° C.) | (63.3° C.) | (21.7° C.) | (63.3° C.) |
| Stirrer | Shear rate, | Shear | Shear | Shear | Shear |
| speed, RPM | Hz | stress | stress | stress | stress |
| 600 | 1022 | 165 | 60 | 101 | 35 |
| 300 | 511 | 93 | 36 | 59 | 21 |
| 200 | 341 | 64 | 26 | 44 | 15 |
| 100 | 170 | 37 | 16 | 22 | 9 |
| 6 | 10 | 10 | 7 | 6 | 3 |
| 3 | 5 | 9 | 6 | 4 | 3 |

| Gel strength at 10 sec., | 19 | 11 | 5 | 4 |
|---|---|---|---|---|
| lb/100 ft² | | | | |
| Gel strength at 10 min., | 29 | 17 | 8 | 5 |
| lb/100 ft² | | | | |
| Electrical stability, V* | 438 | 546 | 112 | 117 |
| Plastic viscosity, cP | 72 | 24 | 42 | 14 |
| Yield Point, lb/100 ft² | 21 | 12 | 17 | 7 |

*Reported values are an average of two runs.

The components and testing results for a mixture containing (2E)-2,3-dibromobut-2-ene-1,4-diyl dipropanoate (2E)-2,3-dibromobut-2-ene-1,4-diyl bis(2-methylpropanoate), and (2E)-2,3-dibromo-4-[(propionyl)oxy]but-2-en-1-yl 2-methylpropanoate are summarized in Tables C1-C2 below. The components are listed in the order added. The hot-rolling temperature was 105° C.

TABLE C1

| Substance | Amount | | Mixing time | | Mixer |
|---|---|---|---|---|---|
| (2E)-2,3-dibromobut-2-ene-1,4-diyl | 114 | mL | — | | — |
| dipropanoate, (2E)-2,3-dibromobut- | | | | | |
| 2-ene-1,4-diyl bis | | | | | |
| (2-methylpropanoate), | | | | | |
| and (2E)-2,3-dibromo-4-[ | | | | | |
| (propionyl)oxy]but-2-en-1-yl 2- | | | | | |
| methylpropanoate | | | | | |
| C₉₋₂₁ hydrocarbons (synthetic oil | 114 | mL | — | | — |
| fluid; Saraline ® 185V) | | | | | |
| organic derivative of hectorite clay | 3 | g | 25 | min. | overhead |
| (Bentone ® 38) | | | | | |
| Tall oil distillates | 8 | g | 10 | min. | overhead |
| (TCM MUL P 350) | | | | | |
| Tall oil distillates | 4 | g | 10 | min. | overhead |
| (TCM MUL S 350) | | | | | |
| Dipropylene glycol | 1 | g | 10 | min. | overhead |
| monomethyl ether | | | | | |
| (Thixatrol ® DW50) | | | | | |
| Ca(OH)₂ (lime) | 5 | g | 10 | min. | overhead |
| CaBr₂ (aq., 14.2 ppg) | 119 | g | 10 | min. | overhead |
| H₂O | 6 | g | 10 | min. | overhead |
| CaCO₃ (Omya ® 04) | 45 | g | 3 | min. | stand |
| CaCO₃ (Omya ® 08) | 30 | g | 3 | min. | stand |
| CaCO₃ (Omya ® 15) | 10 | g | 3 | min. | stand |
| Ethoxylated alkylether sulfate, | 0.5 | g | 10 | min. | stand |
| Na salt (liquid polymeric | | | | | |

viscosifier; Pexovis ® 553)

TABLE C2

| | | Run | | | |
|---|---|---|---|---|---|
| | | 1 | 2 | 3 | 4 |
| | | Before hot-rolling | | After hot-rolling | |
| | | Temperature | | | |
| | | 75° F. | 125° F. | 78° F. | 122° F. |
| | | (24° C.) | (51.7° C.) | (25.6° C.) | (50° C.) |
| Stirrer | Shear | Shear | Shear | Shear | Shear |
| speed, RPM | rate, Hz | stress | stress | stress | stress |
| 600 | 1022 | 131 | 82 | 182 | 86 |
| 300 | 511 | 91 | 55 | 132 | 57 |
| 200 | 341 | 74 | 45 | 104 | 44 |
| 100 | 170 | 56 | 34 | 66 | 31 |
| 6 | 10 | 23 | 22 | 29 | 14 |
| 3 | 5 | 22 | 21 | 27 | 13 |
| Gel strength at 10 sec., | | 36 | 23 | 39 | 17 |
| lb/100 ft² | | | | | |
| Gel strength at 10 min., | | 37 | 26 | 42 | 20 |
| lb/100 ft² | | | | | |
| Electrical stability, V* | | 1024 | 1187 | 931 | 438 |
| Plastic viscosity, cP | | 40 | 27 | 50 | 29 |
| Yield Point, lb/100 ft² | | 51 | 28 | 82 | 28 |

*Reported values are an average of two runs.

Components and testing results for another mixture containing (2E)-2,3-dibromobut-2-ene-1,4-diyl dipropanoate (2E)-2,3-dibromobut-2-ene-1,4-diyl bis(2-methylpropanoate), and (2E)-2,3-dibromo-4-[(propionyl)oxy]but-2-en-1-yl 2-methylpropanoate are summarized in Tables C3-C4 below. The components are listed in the order added. The hot-rolling temperature was 105° C.

TABLE C3

| | | | Mixing | | |
|---|---|---|---|---|---|
| Substance | Amount | | time | | Mixer |
| (2E)-2,3-dibromobut-2-ene-1,4- | 115 | mL | — | | — |
| diyldipropanoate, (2E)-2,3- | | | | | |
| dibromobut-2- | | | | | |
| (2-methylpropanoate), and (2E)-2,3- | | | | | |
| dibromo-4-[(propionyl)oxy]but-2-en- | | | | | |
| 1-yl 2-methylpropanoate | | | | | |
| C₉₋₂₁ hydrocarbons (synthetic oil | 114 | mL | — | | — |
| fluid; Saraline ® 185V) | | | | | |
| organic derivative of hectorite clay | 3 | g | 25 | min. | overhead |
| (Bentone ® 38) | | | | | |
| Tall oil distillates | 8 | g | 10 | min. | overhead |
| (TCM MUL S 350) | | | | | |
| Tall oil distillates | 4 | g | 10 | min. | overhead |
| (TCM MUL S 350) | | | | | |
| Dipropylene glycol | 1 | g | 10 | min. | overhead |
| monomethyl ether | | | | | |
| (Thixatrol ® DW50) | | | | | |
| Ca(OH)₂ (lime) | 5 | g | 10 | min. | overhead |
| CaBr₂ (aq., 14.2 ppg) | 119 | g | 10 | min. | overhead |
| H₂O | 6 | g | 10 | min. | overhead |
| CaCO₃ (Omya ® 04) | 45 | g | 3 | min. | stand |
| CaCO₃ (Omya ® 08) | 30 | g | 3 | min. | stand |
| CaCO₃ (Omya ® 15) | 10 | g | 3 | min. | stand |
| Ethoxylated alkylether sulfate, | 0.5 | g | 10 | min. | stand |
| Na salt (liquid polymeric | | | | | |

viscosifier; Pexovis ® 553)

TABLE C4

| | | Run | | | |
|---|---|---|---|---|---|
| | | 1 | 2 | 3 | 4 |
| | | Before hot-rolling | | After hot-rolling | |
| | | Temperature | | | |
| | | 75° F. | 124° F. | 75° F. | 125° F. |
| | | (23.9° C.) | (51.1° C.) | (23.9° C.) | (51.7° C.) |
| Stirrer | Shear | Shear | Shear | Shear | Shear |
| speed, RPM | rate, Hz | stress | stress | stress | stress |
| 600 | 1022 | 131 | 82 | 182 | 86 |
| 300 | 511 | 91 | 55 | 132 | 57 |
| 200 | 341 | 74 | 45 | 104 | 44 |
| 100 | 170 | 56 | 34 | 66 | 31 |
| 6 | 10 | 23 | 22 | 29 | 14 |
| 3 | 5 | 22 | 21 | 27 | 13 |
| Gel strength at | | 36 | 23 | 39 | 17 |
| 10 sec., lb/100 ft² | | | | | |
| Gel strength at | | 37 | 26 | 42 | 20 |
| 10 min., lb/100 ft² | | | | | |
| Electrical stability, | | 1024 | 1187 | 931 | 438 |
| V* | | | | | |
| Plastic viscosity, | | 40 | 27 | 50 | 29 |
| cP | | | | | |
| Yield Point, | | 51 | 28 | 82 | 28 |
| lb/100 ft² | | | | | |

*Reported values are an average of two runs.

Components and testing results for another mixture containing (2E)-2,3-dibromobut-2-ene-1,4-diyl dipropanoate (2E)-2,3-dibromobut-2-ene-1,4-diyl bis(2-methylpropanoate), and (2E)-2,3-dibromo-4-[(propionyl)oxy]but-2-en-1-yl 2-methylpropanoate are summarized in Tables C5-C6 below. The components are listed in the order added. The hot-rolling temperature was 149° C.

TABLE C5

| | | | Mixing | | |
|---|---|---|---|---|---|
| Substance | Amount | | time | | Mixer |
| (2E)-2,3-dibromobut-2-ene-1,4-diyl | 325 | mL | — | | |
| dipropanoate, (2E)-2,3-dibromobut- | | | | | |
| 2-ene-1,4-diyl bis(2-methylpropanoate), | | | | | |
| and (2E)-2,3-dibromo-4-[(propionyl) | | | | | |
| oxy]but-2-en-1-y1 2-methylpropanoate | | | | | |
| organic derivative of bentonite clay | 10 | g | 30 | min. | overhead |
| (Claytone ® EM) | | | | | |
| Hydrotreated tall oil distillate | 1 | g | 10 | min. | overhead |
| (AES MULX) | | | | | |
| Hydrotreated tall oil distillate | 2 | g | 10 | min. | overhead |
| (AES MULX) | | | | | |
| Dipropylene glycol monomethyl ether | 1 | g | 10 | min. | overhead |
| (Thixatrol ® DW50) | | | | | |
| CaCO₃ (Omya ® 04) | 15 | g | 2 | min. | stand |
| CaCO₃ (Omya ® 08) | 15 | g | 2 | min. | stand |
| CaCO₃ (Omya ® 15) | 7 | g | 2 | min. | stand |
| CaCO₃ (Omya ® Titan 200) | 5 | g | 2 | min. | stand |
| BaSO₄ (barite) | 150 | g | 2 | min. | |
| Ethoxylated alkylether sulfate, Na salt | 1 | g | 10 | min. | stand |
| (liquid polymeric viscosifier; | | | | | |

Pexovis ® 553)

TABLE C6

| | | Run | | | |
|---|---|---|---|---|---|
| | | 1 | 2 | 3 | 4 |
| | | Before hot-rolling | | After hot-rolling | |
| | | Temperature | | | |
| | | 71° F. | 149° F. | 67° F. | 148° F. |
| | | (21.7° C.) | (65° C.) | (19.4° C.) | (64.4° C.) |
| Stirrer | Shear | Shear | Shear | Shear | Shear |
| speed, RPM | rate, Hz | stress | stress | stress | stress |
| 600 | 1022 | 47 | 17 | 47 | 17 |
| 300 | 511 | 29 | 11 | 30 | 11 |
| 200 | 341 | 20 | 8 | 22 | 8 |
| 100 | 170 | 13 | 5 | 13 | 6 |
| 6 | 10 | 3 | 2 | 3 | 2 |
| 3 | 5 | 3 | 2 | 3 | 2 |
| Gel strength at | | 4 | 2 | 3 | 2 |
| 10 sec., lb/100 ft² | | | | | |
| Gel strength at | | 6 | 3 | 5 | 3 |
| 10 min., lb/100 ft² | | | | | |
| Electrical stability, | | >2000 | 1211 | >2000 | 497 |
| V* | | | | | |
| Plastic viscosity, cP | | 18 | 6 | 17 | 6 |
| Yield Point, | | 11 | 5 | 13 | 5 |
| lb/100 ft² | | | | | |

*Reported values are an average of two runs.

The components and testing results for the mixture containing an ester mixture comprising (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate are summarized in Tables D1-D2 below. The components are listed in the order added. The hot-rolling temperature was 105° C.

TABLE D1

| | | | Mixing | | |
|---|---|---|---|---|---|
| Substance | Amount | | time | | Mixer |
| (2E)-2,3-dibromobut-2-ene-1,4-diyl | 55 | mL | — | | — |
| dipropanoate, (2E)-2,3-dibromobut- | | | | | |
| 2-ene-1,4-diyl dibutanoate, and (2E)- | | | | | |
| 2,3-dibromo-4-[[(propionyl)oxy]] | | | | | |
| but-2-en-1-yl butanoate | | | | | |
| C₉₋₂₁ hydrocarbons (synthetic oil | | | — | | — |
| fluid;Saraline ® 185V | 170 | mL | | | |
| organic derivative of hectorite clay | 4 | g | 25 | min. | overhead |
| (Bentone ® 38) | | | | | |
| Hydrotreated distillate and tall oil | 8 | g | 10 | min. | overhead |
| (AES MUL X) | | | | | |
| Hydrotreated distillate and tall oil | 3 | g | 10 | min. | overhead |
| (AES MUL X) | | | | | |
| Dipropylene glycol monomethyl ether | 1.5 | g | 10 | min. | overhead |
| (Thixatrol ® DW50) | | | | | |
| Ca(OH)₂ (lime) | 5 | g | 10 | min. | |
| CaBr₂ (aq., 14.2 ppg) | 119 | g | 10 | min. | |
| H₂O | 6 | g | 10 | min. | |
| CaCO₃ (Omya ® 04) | 45 | g | 2 | min. | stand |
| CaCO₃ (Omya ® 08) | 30 | g | 2 | min. | stand |
| CaCO₃ (Omya ® 15) | 15 | g | 2 | min. | stand |
| Ethoxylated alkylether sulfate, Na salt | 0.5 | g | 10 | min. | stand |
| (liquid polymeric viscosifier; | | | | | |

Pexovis ® 553)

TABLE D2

| | | Run | | | |
|---|---|---|---|---|---|
| | | 1 | 2 | 3 | 4 |
| | | Before hot-rolling | | After hot-rolling | |
| | | Temperature | | | |
| | | 66° F. | 146° F. | 67° F. | 146° F. |
| | | (18.9° C.) | (63.3° C.) | (19.4° C.) | (63.3° C.) |
| Stirrer | Shear | Shear | Shear | Shear | Shear |
| speed, RPM | rate, Hz | stress | stress | stress | stress |
| 600 | 1022 | 73 | 68 | 114 | 44 |
| 300 | 511 | 44 | 46 | 67 | 28 |
| 200 | 341 | 33 | 36 | 52 | 22 |
| 100 | 170 | 21 | 25 | 34 | 16 |
| 6 | 10 | 8 | 14 | 11 | 6 |
| 3 | 5 | 7 | 12 | 9 | 5 |
| Gel strength at | | 9 | 18 | 11 | 7 |
| 10 sec., lb/100 ft² | | | | | |
| Gel strength at | | 17 | 23 | 23 | 10 |
| 10 min., lb/100 ft² | | | | | |
| Electrical stability, | | 207 | 660 | 160 | 133 |
| V* | | | | | |
| Plastic viscosity, | | 29 | 22 | 47 | 16 |
| cP | | | | | |
| Yield Point, | | 15 | 24 | 20 | 12 |
| lb/100 ft² | | | | | |

*Reported values are an average of two runs.

Components and testing results for another mixture containing an ester mixture comprising (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate are summarized in Tables D3-D4 below. The components are listed in the order added. The hot-rolling temperature was 149° C.

TABLE D3

| | | | Mixing | | |
|---|---|---|---|---|---|
| Substance | Amount | | time | | Mixer |
| (2E)-2,3-dibromobut-2-ene-1,4-diyl | 55 | mL | — | | — |
| dipropanoate, (2E)-2,3-dibromobut- | | | | | |
| 2-ene-1,4-diyl dibutanoate, and (2E)- | | | | | |
| 2,3-dibromo-4-[[(propionyl)oxy]] | | | | | |
| but-2-en-1-yl butanoate | | | | | |
| C₉₋₂₁ hydrocarbons (synthetic oil | | | — | | — |
| fluid; Saraline ® 185V | 170 | mL | | | |
| organic derivative of hectorite clay | 4 | g | 25 | min. | overhead |
| (Bentone ® 38) | | | | | |
| Hydrotreated distillate and tall oil | 8 | g | 10 | min. | overhead |
| (AES MUL X) | | | | | |
| Hydrotreated distillate and tall oil | 3 | g | 10 | min. | overhead |
| (AES MUL X) | | | | | |
| Dipropylene glycol monomethyl | 1.5 | g | 10 | min. | overhead |
| ether (Thixatrol ® DW50) | | | | | |
| Ca(OH)₂ (lime) | 5 | g | 10 | min. | |
| CaBr₂ (aq., 14.2 ppg) | 119 | g | 10 | min. | |
| H₂O | 6 | g | 10 | min. | |
| CaCO₃ (Omya ® 04) | 45 | g | 2 | min. | stand |
| CaCO₃ (Omya ® 08) | 30 | g | 2 | min. | stand |
| CaCO₃ (Omya ® 15) | 15 | g | 2 | min. | stand |
| Ethoxylated alkylether sulfate, | 0.5 | g | 10 | min. | stand |
| Na salt (liquid polymeric | | | | | |

viscosifier; Pexovis ® 553)

TABLE D4

| | | Run | | | |
|---|---|---|---|---|---|
| | | 1 | 2 | 3 | 4 |
| | | Before hot-rolling | | After hot-rolling | |
| | | Temperature | | | |
| | | 66° F. | 146° F. | 67° F. | 146° F. |
| | | (18.9° C.) | (63.3° C.) | (19.4° C.) | (63.3° C.) |
| Stirrer | Shear | Shear | Shear | Shear | Shear |
| speed, RPM | rate, Hz | stress | stress | stress | stress |
| 600 | 1022 | 73 | 68 | 114 | 44 |
| 300 | 511 | 44 | 46 | 67 | 28 |
| 200 | 341 | 33 | 36 | 52 | 22 |
| 100 | 170 | 21 | 25 | 34 | 16 |
| 6 | 10 | 8 | 14 | 11 | 6 |
| 3 | 5 | 7 | 12 | 9 | 5 |
| Gel strength at | | 9 | 18 | 11 | 7 |
| 10 sec., lb/100 ft² | | | | | |
| Gel strength at | | 17 | 23 | 23 | 10 |
| 10 min., lb/100 ft² | | | | | |
| Electrical stability, | | 707 | 660 | 160 | 133 |
| V* | | | | | |
| Plastic viscosity, | | 29 | 22 | 47 | 16 |
| cP | | | | | |
| Yield Point, | | 15 | 24 | 20 | 12 |
| lb/100 ft² | | | | | |

*Reported values are an average of two runs.

Several esters of the invention were subjected to the sediment toxicity test described above. Results are summarized in Table E below.

TABLE E

| Ester | Result | Quantity |
|---|---|---|
| 2,2-bis(bromomethyl)1,3-propanediol-1,3-dihexanoate | Pass | >1600 m/kg |
| (2E)-2,3-dibromobut-2-ene-1,4-diyl dipropanoate, (2E)- | Pass | >1600 m/kg |
| 2,3-dibromobut-2-ene-1,4-diyl bis(2-methylpropanoate), | | |
| and (2E)-2,3-dibromo-4-[(propionyl)oxy]but-2-en-1-yl 2- | | |
| methylpropanoate | | |
| (2E)-2,3-dibromobut-2-ene-1,4-diyl bis(propanoate) | Pass | >1600 m/kg |
| 3-bromo-2,2-bis(bromomethyl)propyl pentanoate | Pass | 363 mg/kg (estimate) |
| 3-bromo-2,2-bis(bromomethyl)propyl 2-methylpropanoate | Fail | 243 mg/kg (estimate) |

Several esters of the invention were subjected to the anaerobic biodegradation test described above. Results are summarized in Table F below.

TABLE F

| | | | | Amount |
|---|---|---|---|---|
| Ester(s) | Duration | | Result | biodegradation |
| (2E)-2,3-dibromobut-2-ene-1,4-diyl dipropionate, (2E)- | 275 | days | Pass | 74.25% |
| 2,3-dibromobut-2-ene-1,4-diyl dilineolate, and (2E)-2,3- | | | | |
| dibromo-4-[(propionyl)oxy]but-2-ene-1-yl lineolate | | | | |
| (2E)-2,3-dibromobut-2-ene-1,4-diyl dipropanoate, (2E)- | 275 | days | Pass | 71.7% |
| 2,3-dibromobut-2-ene-1,4-diyl bis(2-methylpropanoate), | | | | |
| and (2E)-2,3-dibromo-4-[(propionyl)oxy]but-2-en-1-yl 2- | | | | |
| methylpropanoate | | | | |
| (2E)-2,3-dibromobut-2-ene-1,4-diyl dipropanoate, (2E)- | 275 | days | Pass | 61.3% |
| 2,3-dibromobut-2-ene-1,4-diyl dibutanoate, (2E)-2,3- | | | | |
| dibromo-4-[(propionyl)oxy]but-2-en-1-yl butanoate, and | | | | |
| 10 wt% propane-1,2,3-triyl tributyrate | | | | |
| (2E)-2,3-dibromobut-2-ene-1,4-diyl dipropanoate, (2E)- | 275 | days | Pass | 58.04% |
| 2,3-dibromobut-2-ene-1,4-diyl dibutanoate, and (2E)-2,3- | | | | |
| dibromo-4-[(propionyl)oxy]but-2-en-1-yl butanoate | | | | |
| (2E)-2,3-dibromobut-2-ene-1,4-diyl bis(propanoate) | 275 | days | Pass | 54.64% |
| (2E)-2,3-dibromobut-2-ene-1,4-diyl diacetate, (2E)-2,3- | 275 | days | Pass | 43.6% |
| dibromobut-2-ene-1,4-diyl di(2-methylpropanoate), (2E)- | | | | |
| 2,3-dibromo-4-[(2-methylpropionyl)oxy]but-2-en-1-yl | | | | |
| acetate, (2Z)-but-2-ene-1,4-diyl diacetate, (2Z)-but-2- | | | | |
| ene-1,4-diyl di(2-methylpropionate), and (2Z)-1-[(2- | | | | |
| methylpropionyl)oxy]but-2-ene-4-yl acetate | | | | |
| (3,5-dibromophenyl)methyl butyrate | 275 | days | Fail | 25.1% |
| 2,2-bis(bromomethyl)1,3-propanediol-1,3-dihexanoate | 275 | days | Fail | 7.36% |
| propane-1,2,3-triyl tris(bromoacetate) | 275 | days | Fail | — |
| propane-1,2,3-triyl tris(bromoacetate), propane-1,2,3- | 275 | days | Fail | — |
| triyl tris(hexanoate), propane-1,2,3-triyl | | | | |
| bis(bromoacetate)(hexanoate), and propane-1,2,3-triyl | | | | |
| (bromoacetate)bis(hexanoate) | | | | |
| (2Z)-but-2-ene-1,4-diyl bis(bromoacetate) | 275 | days | Fail | — |
| (3,5-dibromophenyl)methyl pentanoate | 275 | days | Fail | — |
| 3-bromo-2,2-bis(bromomethyl)propyl pentanoate | 150 | days | Fail | — |
| 3-bromo-2,2-bis(bromomethyl)propyl 2- | 150 | days | Fail | — |
| methylpropanoate | | | | |
| 2,3-dibromoallyl 2-methylpropanoate | 67 | days | Fail | — |
| 3-bromo-2,2-bis(bromomethyl)propyl hexanoate | 67 | days | Fail | — |
| (2E)-2,3-dibromobut-2-ene-1,4-diyl bis(2- | 67 | days | Fail | — |
| methylpropanoate) | | | | |

Table G shows the total gas production for five comparative samples and three samples using esters of this invention. The samples were subjected to the anaerobic biodegradation method described above; total gas production was measured with a pressure transducer.

TABLE G

| Sample | Duration | | Total gas production | |
|---|---|---|---|---|
| (2E)-2,3-dibromobut-2-ene-1,4-diyl dipropanoate, (2E)- | 275 | days | 105.05 | mL |
| 2,3-dibromobut-2-ene-1,4-diyl bis(2-methylpropanoate), | | | | |
| and (2E)-2,3-dibromo-4-[(propionyl)oxy]but-2-en-1-yl 2- | | | | |
| methylpropanoate | | | | |
| (2E)-2,3-dibromobut-2-ene-1,4-diyl dipropanoate, (2E)- | 275 | days | 93.43 | mL |
| 2,3-dibromobut-2-ene-1,4-diyl dibutanoate, (2E)-2,3- | | | | |
| dibromo-4-[(propionyl)oxy]but-2-en-1-yl butanoate, and | | | | |
| 10 wt% propane-1,2,3-triyl tributyrate | | | | |
| 2E)-2,3-dibromobut-2-ene-1,4-diyl dipropanoate, (2E)- | 275 | days | 89.78 | mL |
| 2,3-dibromobut-2-ene-1,4-diyl dibutanoate, and (2E)-2,3- | | | | |
| dibromo-4-[(propionyl)oxy]but-2-en-1-yl butanoate | | | | |
| Ethyl oleate (positive control)* | 275 | days | 126.03 | mL |
| 1-hexadecene (intermediate control) * | 275 | days | 82.35 | mL |
| C₁₆₋₁₈ internal olefin (reference fluid)* | 275 | days | 73.78 | mL |
| Squalane (negative control)* | 275 | days | 24.97 | mL |
| Sediment only (control)* | 275 | days | 24.77 | mL |

*Comparative example.

Further embodiments of the invention include, without limitation:

A) A liquid weighting agent containing two or more bromine atoms and having a bromine content of about 35 wt % or more, which liquid weighting agent is selected from
1) a bromine-containing monoester represented by the formula

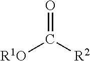

wherein R¹ contains a quaternary carbon atom, a terminal alkene moiety, or an aromatic-alkyl moiety, wherein the oxygen atom adjacent to R¹ is not bound to a quaternary carbon atom, an alkenyl carbon atom or an aromatic carbon atom, and R² is a hydrocarbyl group or a bromine-containing hydrocarbyl group, wherein the bromine-containing monoester is
   i) a bromine-containing monoester that has seven or more carbon atoms and R¹ contains a quaternary carbon atom,
   ii) a bromine-containing monoester that has five or more carbon atoms and R¹ contains a terminal alkene moiety,
   iii) a bromine-containing monoester that has nine or more carbon atoms and R¹ contains an aromatic-alkyl moiety;
2) a bromine-containing diester represented by the formula

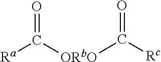

wherein R^{b} contains a quaternary carbon atom or an internal alkene moiety, wherein the oxygen atoms adjacent to R^{b} are not bound to a quaternary carbon atom or an alkenyl carbon atom, and R^{a} and R^{c} are each, independently, a hydrocarbyl group or a bromine-containing hydrocarbyl group, wherein the bromine-containing diester is
   i) a bromine-containing diester that has nine or more carbon atoms and R^{b} contains a quaternary carbon atom,
   ii) a bromine-containing diester that has eight or more carbon atoms and R^{b} contains an internal alkene moiety,
3) a bromine-containing triester which has at least seven carbon atoms and is represented by the formula

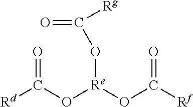

wherein R^{d}, R^{e}, R^{f}, and R^{g} are each, independently, a hydrocarbyl group or a bromine-containing hydrocarbyl group, and at least one of R^{d}, R^{e}, R^{f}, and R^{g} is a bromine-containing hydrocarbyl group; and
4) any two or more of the foregoing.

B) A liquid weighting agent as in A) wherein the bromine-containing monoester in which R¹ contains a quaternary carbon atom has seven to about twenty carbon atoms in the molecule and/or has five to about fifteen carbon atoms in R¹.

C) A liquid weighting agent as in A) wherein the bromine-containing monoester in which R¹ contains a terminal alkene moiety has five to about twenty carbon atoms in the molecule and/or has three to about ten carbon atoms in R¹.

D) A liquid weighting agent as in A) wherein the bromine-containing monoester in which R¹ contains an aromatic-alkyl moiety has nine to about twenty carbon atoms in the molecule and/or has seven to about fifteen carbon atoms in R¹, and/or has an alkyl portion containing one to about four carbon atoms.

E) A liquid weighting agent as in A) wherein the bromine-containing diester in which R^{b} contains a quaternary carbon atom has nine to about thirty carbon atoms in the molecule and/or has five to about ten carbon atoms in R^{b}.

A liquid weighting agent as in A) wherein the bromine-containing diester in which R^{b} contains an internal alkene moiety has eight to about thirty carbon atoms in the molecule and/or has four to about eight carbon atoms in R^{b}.

G) A liquid weighting agent as in A) wherein
R¹ of the bromine-containing monoester has a 2,2-dimethylprop-1-yl moiety as the quaternary carbon moiety;
R¹ of the bromine-containing monoester has a 2-propenyl moiety as the terminal alkene moiety;
R¹ of the bromine-containing monoester has a phenylmethyl moiety as the aromatic-alkyl moiety;
R^{b} of the bromine-containing diester has a 2,2-dimethylpropane-1,3-diyl moiety as quaternary carbon atom moiety;
R^{b} of the bromine-containing diester has a 2-butene moiety as the internal alkene moiety.

H) A liquid weighting agent as in any of A)-G) wherein two or more bromine atoms are bound to carbon atoms adjacent to quaternary carbon atoms, to alkenyl carbon atoms, or to aromatic carbon atoms.

I) A liquid weighting agent as in any of A)-H) wherein
R² of the bromine-containing monoester is a hydrocarbyl group which is a saturated straight chain or a saturated branched chain;
R^{a} or R^{c} of the bromine-containing diester is a hydrocarbyl group which is a saturated straight chain or a saturated branched chain;
R^{a} or R^{c} of the bromine-containing diester is a bromine-containing hydrocarbyl group which is a saturated straight chain or a saturated branched chain.

J) A liquid weighting agent as in any of A)-I) wherein the liquid weighting agent is 3-bromo-2,2-bis(bromomethyl)propyl acetate; 3-bromo-2,2-bis(bromomethyl)propyl propionate; 3-bromo-2,2-bis(bromomethyl)propyl butyrate; 3-bromo-2,2-bis(bromomethyl)propyl 2-methylpropanoate; 3-bromo-2,2-bis(bromomethyl)propyl pentanoate; 3-bromo-2,2-bis(bromomethyl)propyl isovalerate; 3-bromo-2,2-bis(bromomethyl)propyl hexanoate; 2,3-dibromoallyl acetate; 2,3-dibromoallyl propionate; 2,3-dibromoallyl 2-methylpropanoate; (3,5-dibromophenyl)methyl acetate; (3,5-dibromophenyl)methyl bromoacetate; (3,5-dibromophenyl)methyl propionate; (3,5-dibromophenyl)methyl (3,5-dibromophenyl)methyl 2-methylpropanoate; ((3,5-dibromophenyl)methyl pentanoate; 2,2-bis(bromomethyl) 1,3-diacetoxypropane; 2,2-bis(bromomethyl) 1,3-propanediol-1,3-dipropionate; 2,2-bis(bromomethyl) 1,3-propanediol-1,3-di(2-methylpropanoate); 2,2-bis(bromomethyl) 1,3-propanediol-1,3-dihexanoate; 2,2-bis(bromomethyl) 1,3-propanediol-1,3-bis-(bromoaceate); (2E)-2,3-dibromobut-2-ene-1,4-diyl bis(propanoate); (2E)-2,3-dibromobut-2-ene-1,4-diyl bis(2-methylpropanoate); (2E)-2,3-dibromobut-2-ene-1,4-diyl bis(2′-bromobutyrate); (2Z)-but-2-ene-1,4-diyl bis(bromoacetate); and/or 1,2,3-propanetriyl tris (bromoacetate).

K) A liquid weighting agent as in J) wherein the liquid weighting agent is (2E)-2,3-dibromobut-2-ene-1,4-diyl bis(propanoate).

L) A liquid weighting agent as in A) wherein the liquid weighting agent is a mixture of diesters selected from
a) 2,2-bis(bromomethyl)propane-1,3-diyl di (bromoacetate), 3-bromo-2-{[(bromoacetyl)oxy]methyl}-2-(bromomethyl)propyl hexanoate, and 2,2-bis(bromomethyl)propane-1,3-diyl dihexanoate;
b) (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate;
c) (2E)-2,3-dibromobut-2-ene-1,4-diyl dipropanoate, (2E)-2,3-dibromobut-2-ene-1,4-diyl bis(2-methylpropanoate), and (2E)-2,3-dibromo-4-[(propionyl)oxy]but-2-en-1-yl 2-methylpropanoate;
d) (2E)-2,3-dibromobut-2-ene-1,4-diyl bis(bromoacetate), (2E)-2,3-dibromo-4-[(bromoacetyl)oxy]but-2-en-1-yl hexanoate, and (2E)-2,3-dibromobut-2-ene-1,4-diyl dihexanoate;
e) (2E)-2,3-dibromobut-2-ene-1,4-diyl bis(2-methylpropanoate), (2E)-2,3-dibromobut-2-ene-1,4-diyl bis(bromoacetate), and (2E)-2,3-dibromo-4-[(bromoacetyl)oxy]but-2-en-1-yl 2-methylpropanoate;
f) (2E)-2,3-dibromobut-2-ene-1,4-diyl bis(2-methylpropanoate), (2E)-2,3-dibromobut-2-ene-1,4-diyl bis(3-methylbutanoate), and (2E)-2,3-dibromo-4-[(2-methylpropionyl)oxy]but-2-en-1-yl 3-methylbutanoate;
g) (2E)-2,3-dibromobut-2-ene-1,4-diyl dipropionate, (2E)-2,3-dibromobut-2-ene-1,4-diyl dilineolate, and (2E)-2,3-dibromo-4-[(propionyl)oxy]but-2-en-1-yl lineolate;
h) (2E)-2,3-dibromobut-2-ene-1,4-diyl diacetate, (2E)-2,3-dibromobut-2-ene-1,4-diyl propionate, (2E)-2,3-dibromo-4-[(propionyl)oxy]but-2-en-1-yl acetate, (2Z)-2,3-dibromobut-2-ene-1,4-diyl diacetate, (2Z)-2,3-dibromobut-2-ene-1,4-diyl dipropionate, and (2Z)-2,3-dibromo-4-[(propionyl)oxy]but-2-en-1-yl acetate;
i) (2E)-2,3-dibromobut-2-ene-1,4-diyl diacetate, (2E)-2,3-dibromobut-2-ene-1,4-diyl di(2-methylpropanoate), (2E)-2,3-dibromo-4-[2-methylpropionyl)oxy]but-2-en-1-yl acetate, (2Z)-3-but-2-ene-1,4-diyl diacetate, (2Z)-but-2-ene-1,4-diyl dipropionate, and (2Z)-but-2-ene-4-[(propionyl)oxy]but-2-en-1-yl acetate;
j) (2E)-2,3-dibromobut-2-ene-1,4-diyl dibutanoate and 2,2-bis(bromomethyl)propane-1,3-diyl dibutanoate;
k) 2,2-bis(bromomethyl)propane-1,3-diyl diacetate, 2,2-bis(bromomethyl)propane-1,3-diyl dipropionate, 2,2-bis(bromomethyl)propane-1,3-diyl di(2-methylpropanoate), 3-bromo-2-{[acetyloxy]methyl}-2-(bromomethyl)propyl propionate, 3-bromo-2-{[acetyloxy]methyl}-2-(bromomethyl)propyl 2-methylpropanoate, 3-bromo-2-{[(propionyl)oxy]methyl}-2-(bromomethyl)propyl 2-methylpropanoate, (2E)-2,3-dibromobut-2-ene-1,4-diyl diacetate, (2E)-2,3-dibromobut-2-ene-1,4-diyl dipropionate, (2E)-2,3-dibromobut-2-ene-1,4-diyl di(2-methylpropanoate), (2E)-2,3-dibromo-4-[(2-methylpropionyl)oxy]but-2-en-1-yl acetate, (2E)-2,3-dibromo-4-[(2-methylpropionyl)oxy]but-2-en-1-yl propionate, and (2E)-2,3-dibromo-4-[(propionyl)oxy]but-2-en-1-yl acetate;
l) 2,2-bis(bromomethyl)propane-1,3-diyl dipropionate, 2,2-bis(bromomethyl)propane-1,3-diyl dibutyrate, 2,2-bis(bromomethyl)propane-1,3-diyl di(2-methylpropanoate), 3-bromo-2-{[(propionyl)oxy]methyl}-2-(bromomethyl)propyl butyrate, 3-bromo-2-[((propionyl)oxy)methyl]-2-(bromomethyl)propyl 2-methylpropanoate, 3-bromo-2-[(butyryloxy)methyl]-2-(bromomethyl)propyl 2-methylpropanoate, (2E)-2,3-dibromobut-2-ene-1,4-diyl dipropionate, (2E)-2,3-dibromobut-2-ene-1,4-diyl dibutyrate, (2E)-2,3-dibromobut-2-ene-1,4-diyl di(2-methylpropanoate), (2E)-2,3-dibromo-4-[(2-methylpropionyl)oxy]but-2-en-1-yl propionate, (2E)-2,3-dibromo-4-[(2-methylpropionyl)oxy]but-2-en-1-yl butyrate, and (2E)-2,3-dibromo-4-[(butyryl)oxy]but-2-en-1-yl propionate; and
m) propane-1,2,3-triyl tris (bromoacetate), propane-1,2,3-triyl tris (hexanoate), propane-1,2,3-triyl bis(bromoacetate)(hexanoate), and propane-1,2,3-triyl (bromoacetate)bis(hexanoate).

M) A liquid weighting agent as in L) which is a mixture of diesters selected from
a mixture comprising (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate;
a mixture comprising (2E)-2,3-dibromobut-2-ene-1,4-diyl dipropanoate, (2E)-2,3-dibromobut-2-ene-1,4-diyl bis(2-methylpropanoate), and (2E)-2,3-dibromo-4-[(propionyl)oxy]but-2-en-1-yl 2-methylpropanoate;
a mixture comprising (2E)-2,3-dibromobut-2-ene-1,4-diyl dipropionate, (2E)-2,3-dibromobut-2-ene-1,4-diyl dilineolate, and (2E)-2,3-dibromo-4-[(propionyl)oxy]but-2-ene-1-yl lineolate; and
a mixture comprising (2E)-2,3-dibromobut-2-ene-1,4-diyl diacetate, (2E)-2,3-dibromobut-2-ene-1,4-diyl di(2-methylpropanoate), (2E)-2,3-dibromo-4-[(2-methylpropionyl)oxy]but-2-en-1-yl acetate, (2Z)-but-2-ene-1,4-diyl diacetate, (2Z)-but-2-ene-1,4-diyl di(2-methylpropionate), and (2Z)-1-[(2-methylpropionyl)oxy]but-2-ene-4-yl acetate.

N) A liquid weighting agent as in any of A)-M) wherein one or more additives selected from unsaturated diesters that do not contain bromine and/or saturated triesters that do not contain bromine are included with the liquid weighting agent, wherein the unsaturated diester has at least eight carbon atoms and is represented by the formula

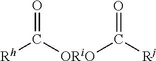

where R^{h} and R^{j} are hydrocarbyl groups, and Rⁱ is an alkene-containing moiety, and wherein the saturated triester has at least seven carbon atoms and is represented by the
formula

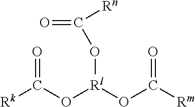

where R^{k}, R^{l}, R^{m}, and Rⁿ are hydrocarbyl groups.

O) A liquid weighting agent as in N) wherein the unsaturated diester is but-2-ene-1,4-diyl bis(butyrate), and wherein the saturated triester is propane-1,2,3-triyl tributyrate.

P) A liquid weighting agent as in M) which is a combination of a mixture of esters comprising (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate with propane-1,2,3-triyl tributyrate.

Q) A liquid weighting agent as in any of A)-P) which is
in a mixture with an oil, wherein there is about 0.1 to about 99.9 wt % liquid weighting agent in the mixture with the oil; or
in combination with a hydraulic fluid.

R) An oil-based well fluid comprising a liquid weighting agent of any of A)-P), optionally wherein the well fluid is a drilling fluid, a completion fluid, a drill-in fluid, a tractor fluid, a camera fluid, or a workover fluid.

S) A method of treating a wellbore, said method comprising introducing into the wellbore a fluid comprising a liquid weighting agent as in any of A)-P), optionally wherein the fluid is a drilling fluid, a completion fluid, a drill-in fluid, a tractor fluid, a camera fluid, or a workover fluid.

T) A method for minimizing or relieving a sustained casing pressure in an annulus of a wellbore, wherein the annulus contains a first fluid having a density, the method comprising introducing a second fluid into the annulus, wherein the second fluid has a density greater than the density of the first fluid and the second fluid is immiscible with the first fluid, characterized in that the second fluid comprises a liquid weighting agent of any of A)-P).

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A liquid weighting agent containing two or more bromine atoms and having a bromine content of about 35 wt % or more, which liquid weighting agent is selected from
A) a bromine-containing monoester represented by the formula 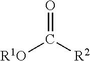
wherein R¹ contains a quaternary carbon atom, a terminal alkene moiety, or an aromatic-alkyl moiety, wherein the oxygen atom adjacent to R¹ is not bound to a quaternary carbon atom, an alkenyl carbon atom or an aromatic carbon atom, and R² is a hydrocarbyl group or a bromine-containing hydrocarbyl group, wherein the bromine-containing monoester is
i) a bromine-containing monoester that has seven or more carbon atoms and R¹ contains a quaternary carbon atom,
ii) a bromine-containing monoester that has five or more carbon atoms and R¹ contains a terminal alkene moiety,
iii) a bromine-containing monoester that has nine or more carbon atoms and R¹ contains an aromatic-alkyl moiety;
B) a bromine-containing diester represented by the formula 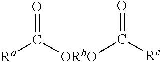
wherein R^{b} contains a quaternary carbon atom or an internal alkene moiety, wherein the oxygen atoms adjacent to R^{b} are not bound to a quaternary carbon atom or an alkenyl carbon atom, and R^{a} and R^{c} are each, independently, a hydrocarbyl group or a bromine-containing hydrocarbyl group, wherein the bromine-containing diester is
i) a bromine-containing diester that has nine or more carbon atoms and R^{b} contains a quaternary carbon atom,
ii) a bromine-containing diester that has eight or more carbon atoms and R^{b} contains an internal alkene moiety,
C) a bromine-containing triester which has at least seven carbon atoms and is represented by the formula 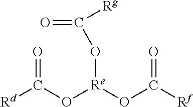
wherein R_{d}, Rₑ, R_{f}, and R_{g} are each, independently, a hydrocarbyl group or a bromine-containing hydrocarbyl group, and at least one of R_{d}, Rₑ, R_{f}, and R^{g} is a bromine-containing hydrocarbyl group; and
D) any two or more of the foregoing.

2. A liquid weighting agent as in claim 1 wherein
the bromine-containing monoester in which R¹ contains a quaternary carbon atom has seven to about twenty carbon atoms in the molecule;
the bromine-containing monoester in which R¹ contains a terminal alkene moiety has five to about twenty carbon atoms in the molecule;
the bromine-containing monoester in which R¹ contains an aromatic-alkyl moiety has nine to about twenty carbon atoms in the molecule;
the bromine-containing diester in which R^{b} contains a quaternary carbon atom has nine to about thirty carbon atoms in the molecule; and
the bromine-containing diester in which R^{b} contains an internal alkene moiety has eight to about thirty carbon atoms in the molecule.

3. A liquid weighting agent as in claim 1 wherein
the bromine-containing monoester in which R¹ contains a quaternary carbon atom has five to about fifteen carbon atoms in R¹;
the bromine-containing monoester in which R¹ contains a terminal alkene moiety has three to about ten carbon atoms in R¹;
the bromine-containing monoester in which R¹ contains an aromatic-alkyl moiety has seven to about fifteen carbon atoms in R¹;
the bromine-containing diester in which R^{b} contains a quaternary carbon atom has five to about ten carbon atoms in R^{b}; and
the bromine-containing diester in which R^{b} contains an internal alkene moiety has four to about eight carbon atoms in R^{b}.

4. A liquid weighting agent as in claim 1 wherein the bromine-containing monoester in which R¹ contains an aromatic-alkyl moiety has an alkyl portion containing one to about four carbon atoms.

5. A liquid weighting agent as in claim 1 wherein
R² of the bromine-containing monoester is a hydrocarbyl group which is a saturated straight chain or a saturated branched chain;
Rₐ or R_{c} of the bromine-containing diester is a hydrocarbyl group which is a saturated straight chain or a saturated branched chain;
Rₐ or R_{c} of the bromine-containing diester is a bromine-containing hydrocarbyl group which is a saturated straight chain or a saturated branched chain.

6. A liquid weighting agent as in claim 1 wherein
R¹ of the bromine-containing monoester has a 2,2-dimethylprop-1-yl moiety as the quaternary carbon moiety;
R¹ of the bromine-containing monoester has a 2-propenyl moiety as the terminal alkene moiety;
R¹ of the bromine-containing monoester has a phenylmethyl moiety as the aromatic-alkyl moiety;
R^{b} of the bromine-containing diester has a 2,2-dimethylpropane-1,3-diyl moiety as quaternary carbon atom moiety;
R^{b} of the bromine-containing diester has a 2-butene moiety as the internal alkene moiety.

7. A liquid weighting agent as in claim 1 wherein two or more bromine atoms are bound to carbon atoms adjacent to quaternary carbon atoms, to alkenyl carbon atoms, or to aromatic carbon atoms.

8. A liquid weighting agent as in claim 1 wherein the liquid weighting agent is 3-bromo-2,2-bis(bromomethyl)propyl acetate; 3-bromo-2,2-bis(bromomethyl)propyl propionate; 3-bromo-2,2-bis(bromomethyl)propyl butyrate; 3-bromo-2,2-bis(bromomethyl)propyl 2-methylpropanoate; 3-bromo-2,2-bis(bromomethyl)propyl pentanoate; 3-bromo-2,2-bis(bromomethyl)propyl isovalerate; 3-bromo-2,2-bis(bromomethyl)propyl hexanoate; 2,3-dibromoallyl acetate; 2,3-dibromoallyl propionate; 2,3-dibromoallyl 2-methylpropanoate; (3,5-dibromophenyl)methyl acetate; (3,5-dibromophenyl)methyl bromoacetate; (3,5-dibromophenyl)methyl propionate; (3,5-dibromophenyl)methyl butyrate; (3,5-dibromophenyl)methyl 2-methylpropanoate; (3,5-dibromophenyl)methyl pentanoate; 2,2-bis(bromomethyl) 1,3-diacetoxypropane; 2,2-bis(bromomethyl) 1,3-propanediol-1,3-dipropionate; 2,2-bis(bromomethyl) 1,3-propanediol-1,3-di(2-methylpropanoate); 2,2-bis(bromomethyl) 1,3-propanediol-1,3-dihexanoate; 2,2-bis(bromomethyl) 1,3-propanediol-1,3-bis-(bromoacetate); (2E)-2,3-dibromobut-2-ene-1,4-diyl bis(propanoate); (2E)-2,3-dibromobut-2-ene-1,4-diyl bis(2-methylpropanoate); (2E)-2,3-dibromobut-2-ene-1,4-diyl bis(2′-bromobutyrate); (2Z)-but-2-ene-1,4-diyl bis(bromoacetate); and/or 1,2,3-propanetriyl tris (bromoacetate).

9. A liquid weighting agent as in claim 8 wherein the liquid weighting agent is (2E)-2,3-dibromobut-2-ene-1,4-diyl bis(propanoate).

10. A liquid weighting agent as in claim 1 wherein the liquid weighting agent is a mixture of diesters selected from
a) 2,2-bis(bromomethyl)propane-1,3-diyl di (bromoacetate), 3-bromo-2-{[(bromoacetyl)oxy]methyl}-2-(bromomethyl)propyl hexanoate, and 2,2-bis(bromomethyl)propane-1,3-diyl dihexanoate;
b) (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate;
c) (2E)-2,3-dibromobut-2-ene-1,4-diyl dipropanoate, (2E)-2,3-dibromobut-2-ene-1,4-diyl bis(2-methylpropanoate), and (2E)-2,3-dibromo-4-[(propionyl)oxy]but-2-en-1-yl 2-methylpropanoate;
d) (2E)-2,3-dibromobut-2-ene-1,4-diyl bis(bromoacetate), (2E)-2,3-dibromo-4-[(bromoacetyl)oxy]but-2-en-1-yl hexanoate, and (2E)-2,3-dibromobut-2-ene-1,4-diyl dihexanoate;
e) (2E)-2,3-dibromobut-2-ene-1,4-diyl bis(2-methylpropanoate), (2E)-2,3-dibromobut-2-ene-1,4-diyl bis(bromoacetate), and (2E)-2,3-dibromo-4-[(bromoacetyl)oxy]but-2-en-1-yl 2-methylpropanoate;
f) (2E)-2,3-dibromobut-2-ene-1,4-diyl bis(2-methylpropanoate), (2E)-2,3-dibromobut-2-ene-1,4-diyl bis(3-methylbutanoate), and (2E)-2,3-dibromo-4-[(2-methylpropionyl)oxy]but-2-en-1-yl 3-methylbutanoate;
g) (2E)-2,3-dibromobut-2-ene-1,4-diyl dipropionate, (2E)-2,3-dibromobut-2-ene-1,4-diyl dilineolate, and (2E)-2,3-dibromo-4-[(propionyl)oxy]but-2-en-1-yl lineolate;
h) (2E)-2,3-dibromobut-2-ene-1,4-diyl diacetate, (2E)-2,3-dibromobut-2-ene-1,4-diyl propionate, (2E)-2,3-dibromo-4-[(propionyl)oxy]but-2-en-1-yl acetate, (2Z)-2,3-dibromobut-2-ene-1,4-diyl diacetate, (2Z)-2,3-dibromobut-2-ene-1,4-diyl dipropionate, and (2Z)-2,3-dibromo-4-[(propionyl)oxy]but-2-en-1-yl acetate;
i) (2E)-2,3-dibromobut-2-ene-1,4-diyl diacetate, (2E)-2,3-dibromobut-2-ene-1,4-diyl di(2-methylpropanoate), (2E)-2,3-dibromo-4-[2-methylpropionyl)oxy]but-2-en-1-yl acetate, (2Z)-3-but-2-ene-1,4-diyl diacetate, (2Z)-but-2-ene-1,4-diyl dipropionate, and (2Z)-but-2-ene-4-[(propionyl)oxy]but-2-en-1-yl acetate;
j) (2E)-2,3-dibromobut-2-ene-1,4-diyl dibutanoate and 2,2-bis(bromomethyl)propane-1,3-diyl dibutanoate;
k) 2,2-bis(bromomethyl)propane-1,3-diyl diacetate, 2,2-bis(bromomethyl)propane-1,3-diyl dipropionate, 2,2-bis(bromomethyl)propane-1,3-diyl di(2-methylpropanoate), 3-bromo-2-{[acetyloxy]methyl}-2-(bromomethyl)propyl propionate, 3-bromo-2-{[acetyloxy]methyl}-2-(bromomethyl)propyl 2-methylpropanoate, 3-bromo-2-{[(propionyl)oxy]methyl}-2-(bromomethyl)propyl 2-methylpropanoate, (2E)-2,3-dibromobut-2-ene-1,4-diyl diacetate, (2E)-2,3-dibromobut-2-ene-1,4-diyl dipropionate, (2E)-2,3-dibromobut-2-ene-1,4-diyl di(2-methylpropanoate), (2E)-2,3-dibromo-4-[(2-methylpropionyl)oxy]but-2-en-1-yl acetate, (2E)-2,3-dibromo-4-[(2-methylpropionyl)oxy]but-2-en-1-yl propionate, and (2E)-2,3-dibromo-4-[(propionyl)oxy]but-2-en-1-yl acetate;
l) 2,2-bis(bromomethyl)propane-1,3-diyl dipropionate, 2,2-bis(bromomethyl)propane-1,3-diyl dibutyrate, 2,2-bis(bromomethyl)propane-1,3-diyl di(2-methylpropanoate), 3-bromo-2-{[(propionyl)oxy]methyl}-2-(bromomethyl)propyl butyrate, 3-bromo-2-[((propionyl)oxy)methyl]-2-(bromomethyl)propyl 2-methylpropanoate, 3-bromo-2-[(butyryloxy)methyl]-2-(bromomethyl)propyl 2-methylpropanoate, (2E)-2,3-dibromobut-2-ene-1,4-diyl dipropionate, (2E)-2,3-dibromobut-2-ene-1,4-diyl dibutyrate, (2E)-2,3-dibromobut-2-ene-1,4-diyl di(2-methylpropanoate), (2E)-2,3-dibromo-4-[(2-methylpropionyl)oxy]but-2-en-1-yl propionate, (2E)-2,3-dibromo-4-[(2-methylpropionyl)oxy]but-2-en-1-yl butyrate, and (2E)-2,3-dibromo-4-[(butyryl)oxy]but-2-en-1-yl propionate; and
m) propane-1,2,3-triyl tris (bromoacetate), propane-1,2,3-triyl tris (hexanoate), propane-1,2,3-triyl bis(bromoacetate)(hexanoate), and propane-1,2,3-triyl (bromoacetate)bis(hexanoate).

11. A liquid weighting agent as in claim 10 which is a mixture of diesters selected from
a mixture comprising (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate;
a mixture comprising (2E)-2,3-dibromobut-2-ene-1,4-diyl dipropanoate, (2E)-2,3-dibromobut-2-ene-1,4-diyl bis(2-methylpropanoate), and (2E)-2,3-dibromo-4-[(propionyl)oxy]but-2-en-1-yl 2-methylpropanoate;
a mixture comprising (2E)-2,3-dibromobut-2-ene-1,4-diyl dipropionate, (2E)-2,3-dibromobut-2-ene-1,4-diyl dilineolate, and (2E)-2,3-dibromo-4-[(propionyl)oxy]but-2-ene-1-yl lineolate; and
a mixture comprising (2E)-2,3-dibromobut-2-ene-1,4-diyl diacetate, (2E)-2,3-dibromobut-2-ene-1,4-diyl di(2-methylpropanoate), (2E)-2,3-dibromo-4-[(2-methylpropionyl)oxy]but-2-en-1-yl acetate, (2Z)-but-2-ene-1,4-diyl diacetate, (2Z)-but-2-ene-1,4-diyl di(2-methylpropionate), and (2Z)-1-[(2-methylpropionyl)oxy]but-2-ene-4-yl acetate.

12. A liquid weighting agent as in claim 11 which is a combination of a mixture of esters comprising (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate with propane-1,2,3-triyl tributyrate.

13. A liquid weighting agent as in claim 1 wherein one or more additives selected from unsaturated diesters that do not contain bromine and/or saturated triesters that do not contain bromine are included with the liquid weighting agent, wherein the unsaturated diester has at least eight carbon atoms and is represented by the formula 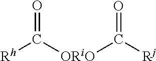
where R^{h} and R^{j} are hydrocarbyl groups, and Rⁱ is an alkene-containing moiety, and wherein the saturated triester has at least seven carbon atoms and is represented by the formula 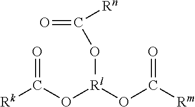
where R^{k}, R^{l}, R^{m}, and Rⁿ are hydrocarbyl groups.

14. A liquid weighting agent as in claim 13 wherein the unsaturated diester is but-2-ene-1,4-diyl bis(butyrate), and wherein the saturated triester is propane-1,2,3-triyl tributyrate.

15. A liquid weighting agent as in claim 1 in a mixture with an oil, wherein there is about 0.1 to about 99.9 wt % liquid weighting agent in the mixture with the oil.

16. A liquid weighting agent as in claim 1 in combination with a hydraulic fluid.

17. An oil-based well fluid comprising a liquid weighting agent of claim 1.

18. An oil-based well fluid as in claim 17 wherein the well fluid is a drilling fluid, a completion fluid, a drill-in fluid, a tractor fluid, a camera fluid, or a workover fluid.

19. A method of treating a wellbore, said method comprising introducing into the wellbore a fluid comprising a liquid weighting agent as in claim 1.

20. A method as in claim 19 wherein the fluid is a drilling fluid, a completion fluid, a drill-in fluid, a tractor fluid, a camera fluid, or a workover fluid.

21. A method for minimizing or relieving a sustained casing pressure in an annulus of a wellbore, wherein the annulus contains a first fluid having a density, the method comprising introducing a second fluid into the annulus, wherein the second fluid has a density greater than the density of the first fluid and the second fluid is immiscible with the first fluid, characterized in that the second fluid comprises a liquid weighting agent of claim 1.

22. Each of the following molecules separately, as a new composition of matter:
3-bromo-2,2-bis(bromomethyl)propyl propionate;
3-bromo-2,2-bis(bromomethyl)propyl butyrate;
3-bromo-2,2-bis(bromomethyl)propyl 2-methylpropanoate;
3-bromo-2,2-bis(bromomethyl)propyl pentanoate;
3-bromo-2,2-bis(bromomethyl)propyl isovalerate;
3-bromo-2,2-bis(bromomethyl)propyl hexanoate;
(3,5-dibromophenyl)methyl propionate;
(3,5-dibromophenyl)methyl butyrate;
(3,5-dibromophenyl)methyl 2-methylpropanoate;
(3,5-dibromophenyl)methyl pentanoate;
2,2-bis(bromomethyl) 1,3-propanediol-1,3-dipropionate;
2,2-bis(bromomethyl) 1,3-propanediol-1,3-di(2-methylpropanoate);
2,2-bis(bromomethyl) 1,3-propanediol-1,3-dihexanoate;
2,2-bis(bromomethyl) 1,3-propanediol-1,3-bis-(bromoacetate);
(2E)-2,3-dibromobut-2-ene-1,4-diyl bis(propanoate);
(2E)-2,3-dibromobut-2-ene-1,4-diyl bis(2-methylpropanoate);
(2Z)-but-2-ene-1,4-diyl bis(bromoacetate);
3-bromo-2-{[(bromoacetyl)oxy]methyl}-2-(bromomethyl)propyl hexanoate;
3-bromo-2-{[acetyloxy]methyl}-2-(bromomethyl)propyl propionate;
3-bromo-2-{[acetyloxy]methyl}-2-(bromomethyl)propyl 2-methylpropanoate;
3-bromo-2-{[(propionyl)oxy]methyl}-2-(bromomethyl)propyl 2-methylpropanoate;
3-bromo-2-{[(propionyl)oxy]methyl}-2-(bromomethyl)propyl butyrate;
3-bromo-2-[(butyryloxy)methyl]-2-(bromomethyl)propyl 2-methylpropanoate;
(2E)-2,3-dibromo-4-[(propionyl)oxy]but-2-en-1-yl butanoate;
(2E)-2,3-dibromo-4-[(propionyl)oxy]but-2-en-1-yl 2-methylpropanoate;
(2E)-2,3-dibromo-4-[(bromoacetyl)oxy]but-2-en-1-yl hexanoate;
(2E)-2,3-dibromo-4-[(bromoacetyl)oxy]but-2-en-1-yl 2-methylpropanoate;
(2E)-2,3-dibromo-4-[(2-methylpropionyl)oxy]but-2-en-1-yl 3-methylbutanoate, (2E)-2,3-dibromo-4-[(propionyl)oxy]but-2-ene-1-yl lineolate;
(2E)-2,3-dibromo-4-[(propionyl)oxy]but-2-en-1-yl acetate;
(2E)-2,3-dibromo-4-[(2-methylpropionyl)oxy]but-2-en-1-yl acetate;
(2E)-2,3-dibromo-4-[(2-methylpropionyl)oxy]but-2-en-1-yl butyrate;
(2Z)-1-[(propionyl)oxy]but-2-ene-4-yl acetate;
(2Z)-1-[(2-methylpropionyl)oxy]but-2-ene-4-yl acetate;
propane-1,2,3-triyl bis(bromoacetate)(hexanoate);
propane-1,2,3-triyl (bromoacetate)bis(hexanoate),
2,2-bis(bromomethyl)propane-1,3-diyl di (bromoacetate);
2,2-bis(bromomethyl)propane-1,3-diyl dibutanoate;
(2E)-2,3-dibromobut-2-ene-1,4-diyl bis(bromoacetate);
(2E)-2,3-dibromobut-2-ene-1,4-diyl dibutanoate;
(2E)-2,3-dibromobut-2-ene-1,4-diyl bis(3-methylbutanoate);
(2E)-2,3-dibromobut-2-ene-1,4-diyl dihexanoate;
(2E)-2,3-dibromobut-2-ene-1,4-diyl dilineolate;
(2Z)-but-2-ene-1,4-diyl diacetate;
(2Z)-but-2-ene-1,4-diyl dipropionate;
(2Z)-but-2-ene-1,4-diyl di(2-methylpropionate);
propane-1,2,3-triyl tris (bromoacetate).

23. Each of the following mixtures of molecules, as a new composition of matter:
a) 2,2-bis(bromomethyl)propane-1,3-diyl di (bromoacetate), 3-bromo-2-{[(bromoacetyl)oxy]methyl}-2-(bromomethyl)propyl hexanoate, and 2,2-bis(bromomethyl)propane-1,3-diyl dihexanoate;
b) (2E)-2,3-dibromobut-2-ene-1,4-diyl dipropanoate, (2E)-2,3-dibromobut-2-ene-1,4-diyl dibutanoate, and (2E)-2,3-dibromo-4-[(propionyl)oxy]but-2-en-1-yl butanoate;
c) (2E)-2,3-dibromobut-2-ene-1,4-diyl dipropanoate, (2E)-2,3-dibromobut-2-ene-1,4-diyl bis(2-methylpropanoate), and (2E)-2,3-dibromo-4-[(propionyl)oxy]but-2-en-1-yl 2-methylpropanoate;
d) (2E)-2,3-dibromobut-2-ene-1,4-diyl bis(bromoacetate), (2E)-2,3-dibromo-4-[(bromoacetyl)oxy]but-2-en-1-yl hexanoate, and (2E)-2,3-dibromobut-2-ene-1,4-diyl dihexanoate;
e) (2E)-2,3-dibromobut-2-ene-1,4-diyl bis(2-methylpropanoate), (2E)-2,3-dibromobut-2-ene-1,4-diyl bis(bromoacetate), and (2E)-2,3-dibromo-4-[(bromoacetyl)oxy]but-2-en-1-yl 2-methylpropanoate;
f) (2E)-2,3-dibromobut-2-ene-1,4-diyl bis(2-methylpropanoate), (2E)-2,3-dibromobut-2-ene-1,4-diyl bis(3-methylbutanoate), and (2E)-2,3-dibromo-4-[(2-methylpropionyl)oxy]but-2-en-1-yl 3-methylbutanoate;
g) (2E)-2,3-dibromobut-2-ene-1,4-diyl dipropionate, (2E)-2,3-dibromobut-2-ene-1,4-diyl dilineolate, and (2E)-2,3-dibromo-4-[(propionyl)oxy]but-2-en-1-yl lineolate;
h) (2E)-2,3-dibromobut-2-ene-1,4-diyl diacetate, (2E)-2,3-dibromobut-2-ene-1,4-diyl propionate, (2E)-2,3-dibromo-4-[(propionyl)oxy]but-2-en-1-yl acetate, (2Z)-2,3-dibromobut-2-ene-1,4-diyl diacetate, (2Z)-2,3-dibromobut-2-ene-1,4-diyl dipropionate, and (2Z)-2,3-dibromo-4-[(propionyl)oxy]but-2-en-1-yl acetate;
i) (2E)-2,3-dibromobut-2-ene-1,4-diyl diacetate, (2E)-2,3-dibromobut-2-ene-1,4-diyl di(2-methylpropanoate), (2E)-2,3-dibromo-4-[2-methylpropionyl)oxy]but-2-en-1-yl acetate, (2Z)-3-but-2-ene-1,4-diyl diacetate, (2Z)-but-2-ene-1,4-diyl dipropionate, and (2Z)-but-2-ene-4-[(propionyl)oxy]but-2-en-1-yl acetate;
j) (2E)-2,3-dibromobut-2-ene-1,4-diyl dibutanoate and 2,2-bis(bromomethyl)propane-1,3-diyl dibutanoate;
k) 2,2-bis(bromomethyl)propane-1,3-diyl diacetate, 2,2-bis(bromomethyl)propane-1,3-diyl dipropionate, 2,2-bis(bromomethyl)propane-1,3-diyl di(2-methylpropanoate), 3-bromo-2-{[acetyloxy]methyl}-2-(bromomethyl)propyl propionate, 3-bromo-2-{[acetyloxy]methyl}-2-(bromomethyl)propyl 2-methylpropanoate, 3-bromo-2-{[(propionyl)oxy]methyl}-2-(bromomethyl)propyl 2-methylpropanoate, (2E)-2,3-dibromobut-2-ene-1,4-diyl diacetate, (2E)-2,3-dibromobut-2-ene-1,4-diyl dipropionate, (2E)-2,3-dibromobut-2-ene-1,4-diyl di(2-methylpropanoate), (2E)-2,3-dibromo-4-[(2-methylpropionyl)oxy]but-2-en-1-yl acetate, (2E)-2,3-dibromo-4-[(2-methylpropionyl)oxy]but-2-en-1-yl propionate, and (2E)-2,3-dibromo-4-[(propionyl)oxy]but-2-en-1-yl acetate;
l) 2,2-bis(bromomethyl)propane-1,3-diyl dipropionate, 2,2-bis(bromomethyl)propane-1,3-diyl dibutyrate, 2,2-bis(bromomethyl)propane-1,3-diyl di(2-methylpropanoate), 3-bromo-2-{[(propionyl)oxy]methyl}-2-(bromomethyl)propyl butyrate, 3-bromo-2-[((propionyl)oxy)methyl]-2-(bromomethyl)propyl 2-methylpropanoate, 3-bromo-2-[(butyryloxy)methyl]-2-(bromomethyl)propyl 2-methylpropanoate, (2E)-2,3-dibromobut-2-ene-1,4-diyl dipropionate, (2E)-2,3-dibromobut-2-ene-1,4-diyl dibutyrate, (2E)-2,3-dibromobut-2-ene-1,4-diyl di(2-methylpropanoate), (2E)-2,3-dibromo-4-[(2-methylpropionyl)oxy]but-2-en-1-yl propionate, (2E)-2,3-dibromo-4-[(2-methylpropionyl)oxy]but-2-en-1-yl butyrate, and (2E)-2,3-dibromo-4-[(butyryl)oxy]but-2-en-1-yl propionate;
m) propane-1,2,3-triyl tris (bromoacetate), propane-1,2,3-triyl tris (hexanoate), propane-1,2,3-triyl bis(bromoacetate)(hexanoate), and propane-1,2,3-triyl (bromoacetate)bis(hexanoate).
